(19) United States
(12) Patent Application Publication
(10) Pub. No.: US 2021/0360549 A1
(43) Pub. Date: Nov. 18, 2021

(54) METHOD AND TERMINAL FOR TRANSMITTING AND RECEIVING SIGNAL IN WIRELESS COMMUNICATION SYSTEM

(71) Applicant: LG ELECTRONICS INC., Seoul (KR)

(72) Inventors: Seungmin Lee, Seoul (KR); Hyukjin Chae, Seoul (KR); Kyuhwan Kwak, Seoul (KR)

(21) Appl. No.: 17/277,584

(22) PCT Filed: Sep. 19, 2019
(86) PCT No.: PCT/KR2019/012124

§ 371 Date: Mar. 18, 2021

Related U.S. Application Data
(60) Provisional application No. 62/734,177, filed on Sep. 20, 2018.
(60) Provisional application No. 62/739,151, filed on Sep. 28, 2018.

(51) Int. Cl. H04W 56/00; H04W 8/24

(52) U.S. Cl. CPC H04W 56/001; H04W 92/18; H04W 8/24; H04W 56/006

(57) ABSTRACT

Presented in one embodiment of the present invention is a method by which a terminal transmits and receives a signal in a wireless communication system, the method comprising the steps of: receiving, by the terminal, a synchronization signal; and transmitting and receiving, by the terminal, a signal to and from a base station or the other terminal on the basis of the received synchronization signal, wherein the terminal identifies the type of synchronization signal on the basis of the degree to which the sequence of the synchronization signal is shifted.

### TECHNICAL FIELD

The following disclosure relates to a wireless communication system, and more particularly, to a method and user equipment for transmitting and receiving signals.

### BACKGROUND ART

As more and more communication devices demand larger communication capacities, the need for enhanced mobile broadband communication relative to the legacy radio access technologies (RATs) has emerged. Massive machine type communication (mMTC) that provides various services by interconnecting multiple devices and things irrespective of time and place is also one of main issues to be addressed for future-generation communications. A communication system design considering services/user equipments (UEs) sensitive to reliability and latency is under discussion as well. As such, the introduction of a future-generation RAT considering enhanced mobile broadband (eMBB), mMTC, ultra-reliability and low latency communication (URLLC), and so on is being discussed. For convenience, this technology is referred to as new RAT (NR) in the present disclosure. NR is an exemplary 5th generation (5G) RAT.

A new RAT system including NR adopts orthogonal frequency division multiplexing (OFDM) or a similar transmission scheme. The new RAT system may use OFDM parameters different from long term evolution (LTE) OFDM parameters. Further, the new RAT system may have a larger system bandwidth (e.g., 100 MHz), while following the legacy LTE/LTE-advanced (LTE-A) numerology. Further, one cell may support a plurality of numerologies in the new RAT system. That is, UEs operating with different numerologies may co-exist within one cell.

Vehicle-to-everything (V2X) is a communication technology of exchanging information between a vehicle and another vehicle, a pedestrian, or infrastructure. V2X may cover four types of communications such as vehicle-to-vehicle (V2V), vehicle-to-infrastructure (V2I), vehicle-to-network (V2N), and vehicle-to-pedestrian (V2P). V2X communication may be provided via a PC5 interface and/or a Uu interface.

### DISCLOSURE

### Technical Task

The present disclosure proposes a method of effectively configuring a sync reference in a situation that an NR base station (gNB) and an LTE base station (eNB) coexist.

It will be appreciated by persons skilled in the art that the objects that could be achieved with the present disclosure are not limited to what has been particularly described hereinabove and the above and other objects that the present disclosure could achieve will be more clearly understood from the following detailed description.

### Technical Solutions

In one technical aspect of the present disclosure, provided is a method of transmitting and receiving signals by a user equipment in a wireless communication system, the method including receiving a synchronization signal by the user equipment and transmitting and receiving the signals with a base station or another user equipment by the user equipment based on the received synchronization signal, wherein the user equipment identifies a type of the synchronization signal based on a shifted extent of a sequence of the synchronization signal.

The type of the synchronization signal may include a sidelink synchronization signal and a synchronization signal transmitted from the base station, and the method may further include determining by the user equipment whether the type of the synchronization signal is the sidelink synchronization signal or the synchronization signal transmitted from the base station based on the shifted extent of the sequence of the synchronization signal.

The type of the synchronization signal may include a synchronization signal transmitted from the base station supportive of a New Radio (NR) communication system and a synchronization signal transmitted from the base station supportive of a Long Term Evolution (LTE) communication system.

The method may further include determining by the user equipment whether the type of the synchronization signal is the synchronization signal transmitted from the base station supportive of the NR communication system or the synchronization signal transmitted from the base station supportive of the LTE communication system.

The method may further include receiving by the user equipment information indicating at least one sync source or at least one sync mode configured per User Equipment (UE) capability from the base station.

The at least one sync mode may include two or more sync modes and the two or more sync modes may include a first sync mode of using a Global Navigation Satellite System (GNSS), an eNB, a gNB, an LTE sidelink user equipment and an NR sidelink user equipment as sync sources and a second sync mode of using the GNSS, the gNB and the NR sidelink user equipment as sync sources.

The first sync mode may be configured for a user equipment having LTE sidelink capability and NR sidelink capability and the second sync mode may be configured for a user equipment having the NR sidelink capability only.

The method may further include transmitting by the user equipment information indicating the type of the base station configured by a first user equipment as the sync reference or the sync source through a Sidelink Synchronization Signal (SLSS) or a Physical Sidelink Broadcast Channel (PSBCH).

The method may further include receiving by the user equipment at least one of information indicating a reference for selecting at least one of the sync reference or the sync source and information indicating a reference for maintaining at least one of the selected sync reference or the selected sync source from the base station.

The method may further include transmitting a signal mapped in order of Physical Sidelink Broadcast Channel (PSBCH), Primary Synchronization Signal (PSS), Secondly Synchronization Signal (SSS) and PSBCH on a time axis.

### Advantageous Effects

According to one embodiment of the present disclosure, as an LTE UE and an NR UE operate in different timings, it is able to prevent a case that at least one Transmission Time Interval (TTI) overlaps in part to work as unstable interference or a case that a portion of TTI is unusable for Transmission/reception.

According to one embodiment of the present disclosure, a sync reference can be effectively configured in a situation that an NR base station (gNB) and an LTE base station (eNB) coexist.

It will be appreciated by persons skilled in the art that the effects that could be achieved with the present disclosure are not limited to what has been particularly described hereinabove and other advantages of the present disclosure will be more clearly understood from the following detailed description.

### DESCRIPTION OF DRAWINGS

The accompanying drawings, which are included to provide a further understanding of the disclosure and are incorporated in and constitute a part of this application, illustrate embodiments of the disclosure and together with the description serve to explain the principle of the disclosure.

FIG. 1 is a diagram showing an example of a frame structure in NR.

FIG. 2 is a diagram showing an example of a resource grid in NR.

FIG. 3 is a diagram for explaining sidelink synchronization.

FIG. 4 shows a time resource unit in which a sidelink synchronization signal is transmitted.

FIG. 5 shows an example of a sidelink resource pool.

FIG. 6 shows a scheduling scheme according to a sidelink transmission mode.

FIG. 7 shows the selection of sidelink transmission resources.

FIG. 8 shows contents related to transmission of the sidelink PSCCH.

FIG. 9 shows contents related to transmission of PSCCH in sidelink V2X.

FIG. 10 is a diagram showing a synchronization source or synchronization criterion in V2X to which the present invention can be applied.

FIGS. 11 to 13 are flowcharts relating to various embodiments of the present disclosure.

FIG. 14 is a diagram showing one embodiment that PSS, PBCH and SSS are mapped to a time/frequency axis.

FIG. 15 is a diagram showing a method of obtaining timing information by a user equipment according to one embodiment of the present disclosure.

FIG. 16 is a flowchart showing one embodiment of the present disclosure.

FIG. 17 is a flowchart showing one embodiment of the present disclosure.

FIG. 18 illustrates a communication system applied to the present disclosure.

FIG. 19 illustrates a wireless device applicable to the present disclosure.

FIG. 20 illustrates a signal process circuit for a transmission signal

FIG. 21 illustrates another example of a wireless device applied to the present disclosure.

FIG. 22 illustrates a hand-held device applied to the present disclosure.

FIG. 23 illustrates a vehicle or an autonomous driving vehicle applied to the present disclosure.

FIG. 24 is a diagram showing a vehicle to which another embodiment of the present disclosure is applicable.

### BEST MODE FOR DISCLOSURE

In this document, downlink (DL) communication refers to communication from a base station (BS) to a user equipment (UE), and uplink (UL) communication refers to communication from the UE to the BS. In DL, a transmitter may be a part of the BS and a receiver may be a part of the UE. In UL, a transmitter may be a part of the UE and a receiver may be a part of the BS. Herein, the BS may be referred to as a first communication device, and the UE may be referred to as a second communication device. The term ‘BS’ may be replaced with ‘fixed station’, ‘Node B’, ‘evolved Node B (eNB)’, ‘next-generation node B (gNB)’, ‘base transceiver system (BTS)’, ‘access point (AP)’, ‘network node’, ‘fifth-generation (5G) network node’, ‘artificial intelligence (AI) system’, ‘road side unit (RSU)’, ‘robot’, etc. The term ‘UE’ may be replaced with ‘terminal’, ‘mobile station (MS)’, ‘user terminal (UT)’, ‘mobile subscriber station (MSS)’, ‘subscriber station (SS)’, ‘advanced mobile station (AMS)’, ‘wireless terminal (WT)’, ‘machine type communication (MTC) device’, ‘machine-to-machine (M2M) device’, ‘device-to-device (D2D) device’, ‘vehicle’, ‘robot’, ‘AI module’, etc.

Techniques described herein may be used in various wireless access systems such as code division multiple access (CDMA), frequency division multiple access (FDMA), time division multiple access (TDMA), orthogonal frequency division multiple access (OFDMA), single carrier-frequency division multiple access (SC-FDMA), etc. CDMA may be implemented as a radio technology such as universal terrestrial radio access (UTRA) or CDMA2000. TDMA may be implemented as a radio technology such as global system for mobile communications (GSM)/general packet radio service (GPRS)/Enhanced Data Rates for GSM Evolution (EDGE). OFDMA may be implemented as a radio technology such as IEEE 802.11 (Wi-Fi), IEEE 802.16 (WiMAX), IEEE 802.20, evolved-UTRA (E-UTRA) etc. UTRA is a part of universal mobile telecommunications system (UMTS). 3GPP LTE is a part of Evolved UMTS (E-UMTS) using E-UTRA. 3GPP LTE employs OFDMA for downlink and SC-FDMA for uplink. LTE-A is an evolution of 3GPP LTE. 3GPP NR (New Radio or New Radio Access Technology) is an evolved version of 3GPP LTE/LTE-A/LTE-A pro.

Although the present disclosure is described based on 3GPP communication systems (e.g., LTE-A, NR, etc.) for clarity of description, the spirit of the present disclosure is not limited thereto. LTE refers to technologies beyond 3GPP technical specification (TS) 36.xxx Release 8. In particular, LTE technologies beyond 3GPP TS 36.xxx Release 10 are referred to as LTE-A, and LTE technologies beyond 3GPP TS 36.xxx Release 13 are referred to as LTE-A pro. 3GPP NR refers to technologies beyond 3GPP TS 38.xxx Release 15. LTE/NR may be called ‘3GPP system’. Herein, “xxx” refers to a standard specification number.

In the present disclosure, a node refers to a fixed point capable of transmitting/receiving a radio signal for communication with a UE. Various types of BSs may be used as the node regardless of the names thereof. For example, the node may include a BS, a node B (NB), an eNB, a pico-cell eNB (PeNB), a home eNB (HeNB), a relay, a repeater, etc. A device other than the BS may be the node. For example, a radio remote head (RRH) or a radio remote unit (RRU) may be the node. The RRH or RRU generally has a lower power level than that of the BS. At least one antenna is installed for each node. The antenna may refer to a physical antenna or mean an antenna port, a virtual antenna, or an antenna group. The node may also be referred to as a point.

In the present disclosure, a cell refers to a prescribed geographical area in which one or more nodes provide communication services or a radio resource. When a cell refers to a geographical area, the cell may be understood as the coverage of a node where the node is capable of providing services using carriers. When a cell refers to a radio resource, the cell may be related to a bandwidth (BW), i.e., a frequency range configured for carriers. Since DL coverage, a range within which the node is capable of transmitting a valid signal, and UL coverage, a range within which the node is capable of receiving a valid signal from the UE, depend on carriers carrying the corresponding signals, the coverage of the node may be related to the coverage of the cell, i.e., radio resource used by the node. Accordingly, the term “cell” may be used to indicate the service coverage of a node, a radio resource, or a range to which a signal transmitted on a radio resource can reach with valid strength.

In the present disclosure, communication with a specific cell may mean communication with a BS or node that provides communication services to the specific cell. In addition, a DL/UL signal in the specific cell refers to a DL/UL signal from/to the BS or node that provides communication services to the specific cell. In particular, a cell providing DL/UL communication services to a UE may be called a serving cell. The channel state/quality of the specific cell may refer to the channel state/quality of a communication link formed between the BS or node, which provides communication services to the specific cell, and the UE.

When a cell is related to a radio resource, the cell may be defined as a combination of DL and UL resources, i.e., a combination of DL and UL component carriers (CCs). The cell may be configured to include only DL resources or a combination of DL and UL resources. When carrier aggregation is supported, a linkage between the carrier frequency of a DL resource (or DL CC) and the carrier frequency of a UL resource (or UL CC) may be indicated by system information transmitted on a corresponding cell. The carrier frequency may be equal to or different from the center frequency of each cell or CC. A cell operating on a primary frequency may be referred to as a primary cell (PCell) or PCC, and a cell operating on a secondary frequency may be referred to as a secondary cell (SCell) or SCC. The SCell may be configured after the UE and BS establish a radio resource control (RRC) connection therebetween by performing an RRC connection establishment procedure, that is, after the UE enters the RRC_CONNECTED state. The RRC connection may mean a path that enables the RRC of the UE and the RRC of the BS to exchange an RRC message. The SCell may be configured to provide additional radio resources to the UE. The SCell and the PCell may form a set of serving cells for the UE depending on the capabilities of the UE. When the UE is not configured with carrier aggregation or does not support the carrier aggregation although the UE is in the RRC_CONNECTED state, only one serving cell configured with the PCell exists.

A cell supports a unique radio access technology (RAT). For example, transmission/reception in an LTE cell is performed based on the LTE RAT, and transmission/reception in a 5G cell is performed based on the 5G RAT.

The carrier aggregation is a technology for combining a plurality of carriers each having a system BW smaller than a target BW to support broadband. The carrier aggregation is different from OFDMA in that in the former, DL or UL communication is performed on a plurality of carrier frequencies each forming a system BW (or channel BW) and in the latter, DL or UL communication is performed by dividing a base frequency band into a plurality of orthogonal subcarriers and loading the subcarriers in one carrier frequency. For example, in OFDMA or orthogonal frequency division multiplexing (OFDM), one frequency band with a predetermined system BW is divided into a plurality of subcarriers with a predetermined subcarrier spacing, and information/data is mapped to the plurality of subcarriers. Frequency up-conversion is applied to the frequency band to which the information/data is mapped, and the information/data is transmitted on the carrier frequency in the frequency band. In wireless carrier aggregation, multiple frequency bands, each of which has its own system BW and carrier frequency, may be simultaneously used for communication, and each frequency band used in the carrier aggregation may be divided into a plurality of subcarriers with a predetermined subcarrier spacing.

3GPP communication specifications define DL physical channels corresponding to resource elements carrying information originating from higher (upper) layers of physical layers (e.g., a medium access control (MAC) layer, a radio link control (RLC) layer, a protocol data convergence protocol (PDCP) layer, an RRC layer, a service data adaptation protocol (SDAP) layer, a non-access stratum (NAS) layer, etc.) and DL physical signals corresponding to resource elements which are used by physical layers but do not carry information originating from higher layers. For example, a physical downlink shared channel (PDSCH), a physical broadcast channel (PBCH), a physical multicast channel (PMCH), a physical control format indicator channel (PCFICH), and a physical downlink control channel (PDCCH) are defined as the DL physical channels, and a reference signal and a synchronization signal are defined as the DL physical signals. A reference signal (RS), which is called a pilot signal, refers to a predefined signal with a specific waveform known to both the BS and UE. For example, a cell-specific RS (CRS), a UE-specific RS (UE-RS), a positioning RS (PRS), a channel state information RS (CSI-RS), and a demodulation reference signal (DMRS) may be defined as DL RSs. In addition, the 3GPP communication specifications define UL physical channels corresponding to resource elements carrying information originating from higher layers and UL physical signals corresponding to resource elements which are used by physical layers but do not carry information originating from higher layers. For example, a physical uplink shared channel (PUSCH), a physical uplink control channel (PUCCH), and a physical random access channel (PRACH) are defined as the UL physical channels, and a demodulation reference signal (DMRS) for a UL control/data signal and a sounding reference signal (SRS) used for UL channel measurement are defined as the UL physical signals.

In the present disclosure, the PDCCH and the PDSCH may refer to a set of time-frequency resources or resource elements carrying downlink control information (DCI) of the physical layer and a set of time-frequency resources or resource elements carrying DL data thereof, respectively. The PUCCH, the PUSCH, and the PRACH may refer to a set of time-frequency resources or resource elements carrying uplink control information (UCI) of the physical layer, a set of time-frequency resources or resource elements carrying UL data thereof, and a set of time-frequency resources or resource elements carrying random access signals thereof, respectively. When it is said that a UE transmits a UL physical channel (e.g., PUCCH, PUSCH, PRACH, etc.), it may mean that the UE transmits DCI, UL data, or a random access signal on or over the corresponding UL physical channel. When it is said that the BS receives a UL physical channel, it may mean that the BS receives DCI, UL data, a random access signal on or over the corresponding UL physical channel. When it is said that the BS transmits a DL physical channel (e.g., PDCCH, PDSCH, etc.), it may mean that the BS transmits DCI or UL data on or over the corresponding DL physical channel. When it is said that the UE receives a DL physical channel, it may mean that the UE receives DCI or UL data on or over the corresponding DL physical channel.

In the present disclosure, a transport block may mean the payload for the physical layer. For example, data provided from the higher layer or MAC layer to the physical layer may be referred to as the transport block.

In the present disclosure, hybrid automatic repeat request (HARQ) may mean a method used for error control. A HARQ acknowledgement (HARQ-ACK) transmitted in DL is used to control an error for UL data, and a HARQ-ACK transmitted in UL is used to control an error for DL data. A transmitter that performs the HARQ operation waits for an ACK signal after transmitting data (e.g. transport blocks or codewords). A receiver that performs the HARQ operation transmits an ACK signal only when the receiver correctly receives data. If there is an error in the received data, the receiver transmits a negative ACK (NACK) signal. Upon receiving the ACK signal, the transmitter may transmit (new) data but, upon receiving the NACK signal, the transmitter may retransmit the data. Meanwhile, there may be a time delay until the BS receives ACK/NACK from the UE and retransmits data after transmitting scheduling information and data according to the scheduling information. The time delay occurs due to a channel propagation delay or a time required for data decoding/encoding. Accordingly, if new data is transmitted after completion of the current HARQ process, there may be a gap in data transmission due to the time delay. To avoid such a gap in data transmission during the time delay, a plurality of independent HARQ processes are used. For example, when there are 7 transmission occasions between initial transmission and retransmission, a communication device may perform data transmission with no gap by managing 7 independent HARQ processes. When the communication device uses a plurality of parallel HARQ processes, the communication device may successively perform UL/DL transmission while waiting for HARQ feedback for previous UL/DL transmission.

In the present disclosure, CSI collectively refers to information indicating the quality of a radio channel (also called a link) created between a UE and an antenna port. The CSI includes at least one of a Channel Quality Indicator (CQI), a Precoding Matrix Indicator (PMI), a CSI-RS Resource Indicator (CRI), an SSB Resource Indicator (SSBRI), a Layer Indicator (LI), a Rank Indicator (RI), or a Reference Signal Received Power (RSRP).

In the present disclosure, frequency division multiplexing (FDM) may mean that signals/channels/users are transmitted/received on different frequency resources, and time division multiplexing (TDM) may mean that signals/channels/users are transmitted/received on different time resources.

In the present disclosure, frequency division duplex (FDD) refers to a communication scheme in which UL communication is performed on a UL carrier and DL communication is performed on a DL carrier linked to the UL carrier, and time division duplex (TDD) refers to a communication scheme in which UL and DL communication are performed by splitting time.

The details of the background, terminology, abbreviations, etc. used herein may be found in documents published before the present disclosure. For example, 3GPP TS 24 series, 3GPP TS 34 series, and 3GPP TS 38 series may be referenced (http://www.3gpp.org/specifications/specification-numbering).

Frame Structure

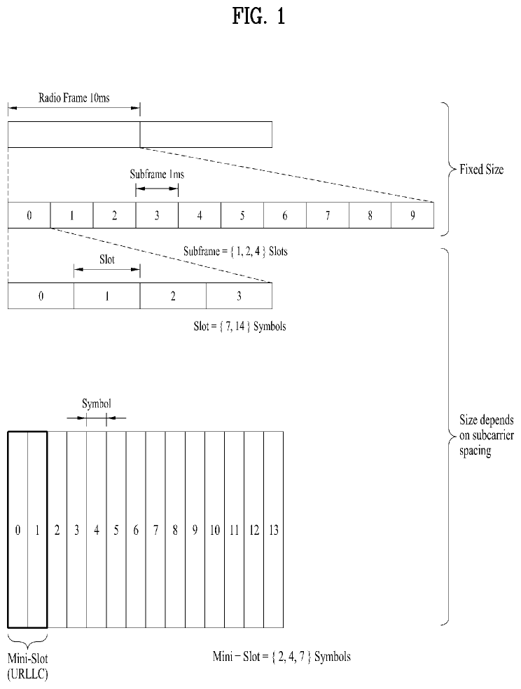

FIG. 1 is a diagram illustrating a frame structure in NR

The NR system may support multiple numerologies. A numerology may be defined by a subcarrier spacing (SCS) and a cyclic prefix (CP) overhead. Multiple SCSs may be derived by scaling a default SCS by an integer N (or μ). Further, even though it is assumed that a very small SCS is not used in a very high carrier frequency, a numerology to be used may be selected independently of a frequency band. Further, the NR system may support various frame structures according to multiple numerologies.

Now, a description will be given of OFDM numerologies and frame structures which may be considered for the NR system. Multiple OFDM numerologies supported by the NR system may be defined as listed in Table 1.

TABLE 1

| μ | Δf = 2^{μ}*15 [kHz] | Cyclic prefix(CP) |
|---|---|---|
| 0 | 15 | Normal |
| 1 | 30 | Normal |
| 2 | 60 | Normal, Extended |
| 3 | 120 | Normal |
| 4 | 240 | Normal |

NR supports a plurality of numerologies (e.g., subcarrier spacings) to support various 5G services. For example, when a subcarrier spacing is 15 kHz, a wide area in traditional cellular bands is supported. When the subcarrier spacing is 30 kHz or 60 kHz, a dense-urban, lower latency, and wider carrier bandwidth are supported. When the subcarrier spacing is 60 kHz or higher, bandwidth greater than 24.25 GHz is supported to overcome phase noise

Resource Grid

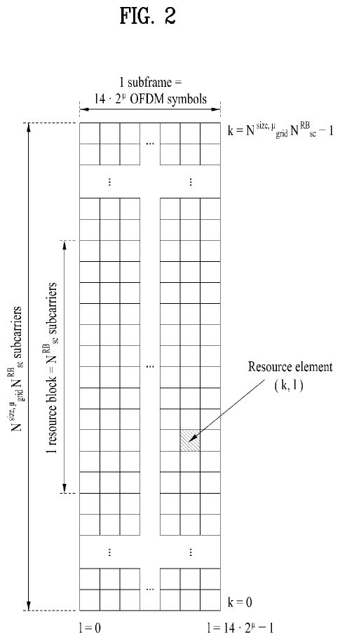

FIG. 2 illustrates an example of a resource grid in NR.

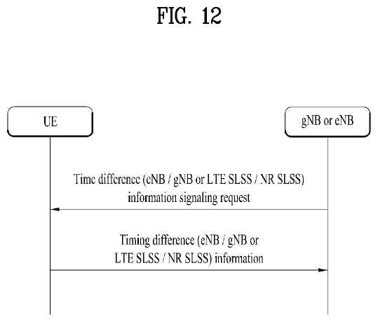

Referring to the resource grid of FIG. 2, there are N_{RB}^{μ}N_{sc}^{RB} subcarriers in the frequency domain, and there are 14·2μ OFDM symbols in one subframe. However, the resource grid is merely exemplary and the present disclosure is not limited thereto. In the NR system, a transmitted signal is described by one or more resource grids, each including N_{RB}^{μ}N_{sc}^{RB} subcarriers, and 2^{μ}N_{symb}^{(μ)} OFDM symbols. In this case, N_{RB}^{μ}≤N_{RB}^{max, μ}. N_{RB}^{max, μ} denotes the maximum transmission bandwidth and may change not only between numerologies but also between uplink and downlink. As shown in FIG. 12, one resource grid may be configured for each numerology μ and antenna port p. Each element of the resource grid for the numerology p and antenna port p is referred to as a resource element, and it is uniquely identified by an index pair (k,l̅), where k is an index in the frequency domain (k=0, . . . , N_{RB}^{μ}N_{sc}^{RB}−1) and \ddot{l} denotes the location of a symbol in the subframe (l̅=0, . . . , 2^{μ}N_{symb}^{(μ)}−1). The resource element (k,l̅) for the numerology μ and antenna port p corresponds to a complex value a_{k,l̅}^{(p,μ)}. When there is no risk of confusion or when a specific antenna port or numerology is not specified, the indexes p and μ may be dropped, and as a result, the complex value may be a_{k,l̅}^{(p)} or a_{k,l̅}. In addition, a resource block (RB) is defined as N_{sc}^{RB}=12 consecutive subcarriers in the frequency domain.

Considering that the UE is incapable of supporting a wide BW supported in the NR system, the UE may be configured to operate in a part of the frequency BW of a cell (hereinafter referred to as a bandwidth part (BWP)).

Bandwidth Part (BWP)

The NR system may support up to 400 MHz for each carrier. If the UE always keeps a radio frequency (RF) module on for all carriers while operating on such a wideband carrier, the battery consumption of the UE may increase. Considering multiple use cases (e.g., eMBB, URLLC, mMTC, V2X, etc.) operating in one wideband carrier, a different numerology (e.g., subcarrier spacing) may be supported for each frequency band of the carrier. Further, considering that each UE may have a different capability regarding the maximum BW, the BS may instruct the UE to operate only in a partial BW rather than the whole BW of the wideband carrier. The partial bandwidth is referred to as the BWP. The BWP is a subset of contiguous common RBs defined for numerology μi in BWP i of the carrier in the frequency domain, and one numerology (e.g., subcarrier spacing, CP length, and/or slot/mini-slot duration) may be configured for the BWP.

The BS may configure one or more BWPs in one carrier configured for the UE. Alternatively, if UEs are concentrated in a specific BWP, the BS may move some UEs to another BWP for load balancing. For frequency-domain inter-cell interference cancellation between neighbor cells, the BS may configure BWPs on both sides of a cell except for some central spectra in the whole BW in the same slot. That is, the BS may configure at least one DL/UL BWP for the UE associated with the wideband carrier, activate at least one of DL/UL BWP(s) configured at a specific time (by L1 signaling which is a physical-layer control signal, a MAC control element (CE) which is a MAC-layer control signal, or RRC signaling), instruct the UE to switch to another configured DL/UL BWP (by L1 signaling, a MAC CE, or RRC signaling), or set a timer value and switch the UE to a predetermined DL/UL BWP upon expiration of the timer value. In particular, an activated DL/UL BWP is referred to as an active DL/UL BWP. While performing initial access or before setting up an RRC connection, the UE may not receive a DL/UL BWP configuration. A DL/UL BWP that the UE assumes in this situation is referred to as an initial active DL/UL BWP.

Synchronization Acquisition of Sidelink UE

In TDMA and FDMA systems, accurate time and frequency synchronization is essential. Inaccurate time and frequency synchronization may lead to degradation of system performance due to inter-symbol interference (ISI) and inter-carrier interference (ICI). The same is true for V2X. For time/frequency synchronization in V2X, a sidelink synchronization signal (SLSS) may be used in the PHY layer, and master information block-sidelink-V2X (MIB-SL-V2X) may be used in the RLC layer.

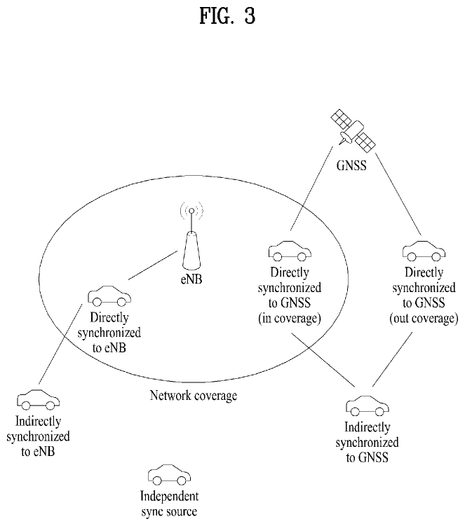

FIG. 3 illustrates a V2X synchronization source or reference to which the present disclosure is applicable.

Referring to FIG. 3, in V2X, a UE may be synchronized with a GNSS directly or indirectly through a UE (within or out of network coverage) directly synchronized with the GNSS. When the GNSS is configured as a synchronization source, the UE may calculate a direct subframe number (DFN) and a subframe number by using a coordinated universal time (UTC) and a (pre)determined DFN offset.

Alternatively, the UE may be synchronized with a BS directly or with another UE which has been time/frequency synchronized with the BS. For example, the BS may be an eNB or a gNB. For example, when the UE is in network coverage, the UE may receive synchronization information provided by the BS and may be directly synchronized with the BS. Thereafter, the UE may provide synchronization information to another neighboring UE. When a BS timing is set as a synchronization reference, the UE may follow a cell associated with a corresponding frequency (when within the cell coverage in the frequency), a primary cell, or a serving cell (when out of cell coverage in the frequency), for synchronization and DL measurement.

The BS (e.g., serving cell) may provide a synchronization configuration for a carrier used for V2X or sidelink communication. In this case, the UE may follow the synchronization configuration received from the BS. When the UE fails in detecting any cell in the carrier used for the V2X or sidelink communication and receiving the synchronization configuration from the serving cell, the UE may follow a predetermined synchronization configuration.

Alternatively, the UE may be synchronized with another UE which has not obtained synchronization information directly or indirectly from the BS or GNSS. A synchronization source and a preference may be preset for the UE. Alternatively, the synchronization source and the preference may be configured for the UE by a control message provided by the BS.

Hereinbelow, the SLSS and synchronization information will be described.

The SLSS may be a sidelink-specific sequence and include a primary sidelink synchronization signal (PSSS) and a secondary sidelink synchronization signal (SSSS).

Each SLSS may have a physical layer sidelink synchronization identity (ID), and the value may be, for example, any of 0 to 335. The synchronization source may be identified depending on which of the above values is used. For example, 0, 168, and 169 may indicate the GNSS, 1 to 167 may indicate the BS, and 170 to 335 may indicate out-of-coverage. Alternatively, among the values of the physical layer sidelink synchronization ID, 0 to 167 may be used by the network, and 168 to 335 may be used for the out-of-coverage state.

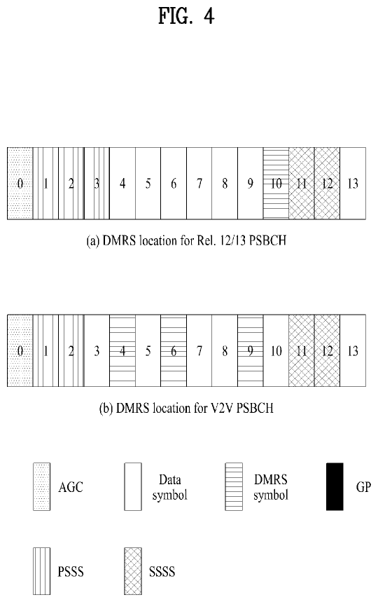

FIG. 4 illustrates a time resource unit for SLSS transmission. The time resource unit may be a subframe in LTE/LTE-A and a slot in 5G. The details may be found in 3GPP TS 36 series or 3GPP TS 28 series. A physical sidelink broadcast channel (PSBCH) may refer to a channel for carrying (broadcasting) basic (system) information that the UE needs to know before sidelink signal transmission and reception (e.g., SLSS-related information, a duplex mode (DM), a TDD UL/DL configuration, information about a resource pool, the type of an SLSS-related application, a subframe offset, broadcast information, etc.). The PSBCH and SLSS may be transmitted in the same time resource unit, or the PSBCH may be transmitted in a time resource unit after that in which the SLSS is transmitted. A DMRS may be used to demodulate the PSBCH.

Sidelink Transmission Mode

For sidelink communication, transmission modes 1, 2, 3 and 4 are used.

In transmission mode 1/3, the BS performs resource scheduling for UE 1 over a PDCCH (more specifically, DCI) and UE 1 performs D2D/V2X communication with UE 2 according to the corresponding resource scheduling. After transmitting sidelink control information (SCI) to UE 2 over a physical sidelink control channel (PSCCH), UE 1 may transmit data based on the SCI over a physical sidelink shared channel (PSSCH). Transmission modes 1 and 3 may be applied to D2D and V2X, respectively.

Transmission mode 2/4 may be a mode in which the UE performs autonomous scheduling (self-scheduling). Specifically, transmission mode 2 is applied to D2D. The UE may perform D2D operation by autonomously selecting a resource from a configured resource pool. Transmission mode 4 is applied to V2X. The UE may perform V2X operation by autonomously selecting a resource from a selection window through a sensing process. After transmitting the SCI to UE 2 over the PSCCH, UE 1 may transmit data based on the SCI over the PSSCH. Hereinafter, the term ‘transmission mode’ may be simply referred to as ‘mode’.

Control information transmitted by a BS to a UE over a PDCCH may be referred to as DCI, whereas control information transmitted by a UE to another UE over a PSCCH may be referred to as SCI. The SCI may carry sidelink scheduling information. The SCI may have several formats, for example, SCI format 0 and SCI format 1.

SCI format 0 may be used for scheduling the PSSCH. SCI format 0 may include a frequency hopping flag (1 bit), a resource block allocation and hopping resource allocation field (the number of bits may vary depending on the number of sidelink RBs), a time resource pattern (7 bits), a modulation and coding scheme (MCS) (5 bits), a time advance indication (11 bits), a group destination ID (8 bits), etc.

SCI format 1 may be used for scheduling the PSSCH. SCI format 1 may include a priority (3 bits), a resource reservation (4 bits), the location of frequency resources for initial transmission and retransmission (the number of bits may vary depending on the number of sidelink subchannels), a time gap between initial transmission and retransmission (4 bits), an MCS (5 bits), a retransmission index (1 bit), a reserved information bit, etc. Hereinbelow, the term ‘reserved information bit’ may be simply referred to as ‘reserved bit’. The reserved bit may be added until the bit size of SCI format 1 becomes 32 bits.

SCI format 0 may be used for transmission modes 1 and 2, and SCI format 1 may be used for transmission modes 3 and 4.

Sidelink Resource Pool

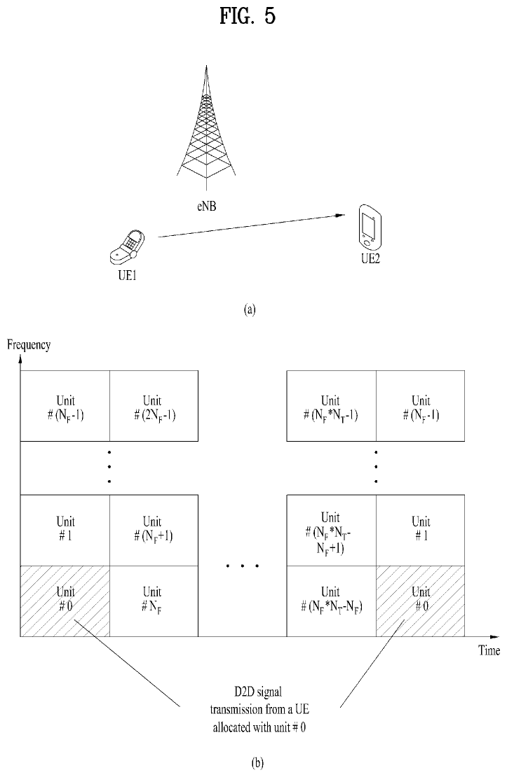

FIG. 5 shows an example of a first UE (UE1), a second UE (UE2) and a resource pool used by UE1 and UE2 performing sidelink communication.

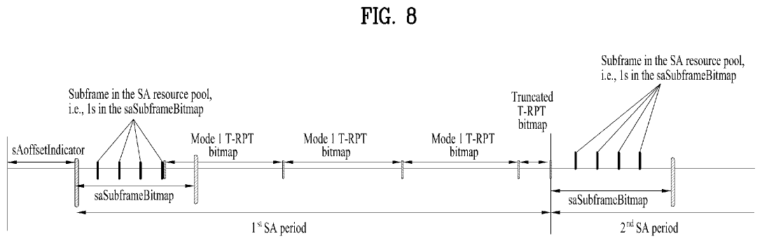

In FIG. 5(a), a UE corresponds to a terminal or such a network device as an eNB transmitting and receiving a signal according to a sidelink communication scheme. A UE selects a resource unit corresponding to a specific resource from a resource pool corresponding to a set of resources and the UE transmits a sidelink signal using the selected resource unit. UE2 corresponding to a receiving UE receives a configuration of a resource pool in which UE1 is able to transmit a signal and detects a signal of UE1 in the resource pool. In this case, if UE1 is located at the inside of coverage of an eNB, the eNB may inform UE1 of the resource pool. If UE1 is located at the outside of coverage of the eNB, the resource pool may be informed by a different UE or may be determined by a predetermined resource. In general, a resource pool includes a plurality of resource units. A UE selects one or more resource units from among a plurality of the resource units and may be able to use the selected resource unit(s) for sidelink signal transmission. FIG. 5(b) shows an example of configuring a resource unit. Referring to FIG. 5(b), the entire frequency resources are divided into the NF number of resource units and the entire time resources are divided into the NT number of resource units. In particular, it is able to define NF*NT number of resource units in total. In particular, a resource pool may be repeated with a period of NT subframes. Specifically, as shown in FIG. 8, one resource unit may periodically and repeatedly appear. Or, an index of a physical resource unit to which a logical resource unit is mapped may change with a predetermined pattern according to time to obtain a diversity gain in time domain and/or frequency domain. In this resource unit structure, a resource pool may correspond to a set of resource units capable of being used by a UE intending to transmit a sidelink signal.

A resource pool may be classified into various types. First of all, the resource pool may be classified according to contents of a sidelink signal transmitted via each resource pool. For example, the contents of the sidelink signal may be classified into various signals and a separate resource pool may be configured according to each of the contents. The contents of the sidelink signal may include a scheduling assignment (SA or physical sidelink control channel (PSCCH)), a sidelink data channel, and a discovery channel. The SA may correspond to a signal including information on a resource position of a sidelink data channel, information on a modulation and coding scheme (MCS) necessary for modulating and demodulating a data channel, information on a MIMO transmission scheme, information on a timing advance (TA), and the like. The SA signal may be transmitted on an identical resource unit in a manner of being multiplexed with sidelink data. In this case, an SA resource pool may correspond to a pool of resources that an SA and sidelink data are transmitted in a manner of being multiplexed. The SA signal may also be referred to as a sidelink control channel or a physical sidelink control channel (PSCCH). The sidelink data channel (or, physical sidelink shared channel (PSSCH)) corresponds to a resource pool used by a transmitting UE to transmit user data. If an SA and a sidelink data are transmitted in a manner of being multiplexed in an identical resource unit, sidelink data channel except SA information may be transmitted only in a resource pool for the sidelink data channel. In other word, REs, which are used to transmit SA information in a specific resource unit of an SA resource pool, may also be used for transmitting sidelink data in a sidelink data channel resource pool. The discovery channel may correspond to a resource pool for a message that enables a neighboring UE to discover transmitting UE transmitting information such as ID of the UE, and the like.

Although contents of sidelink signal are identical to each other, it may use a different resource pool according to a transmission/reception attribute of the sidelink signal. For example, in case of the same sidelink data channel or the same discovery message, the sidelink data channel or the discovery signal may be classified into a different resource pool according to a transmission timing determination scheme (e.g., whether a sidelink signal is transmitted at the time of receiving a synchronization reference signal or the timing to which a prescribed timing advance is added) of a sidelink signal, a resource allocation scheme (e.g., whether a transmission resource of an individual signal is designated by an eNB or an individual transmitting UE selects an individual signal transmission resource from a pool), a signal format (e.g., number of symbols occupied by a sidelink signal in a subframe, number of subframes used for transmitting a sidelink signal), signal strength from an eNB, strength of transmit power of a sidelink UE, and the like. For clarity, a method for an eNB to directly designate a transmission resource of a sidelink transmitting UE is referred to as a mode 1 (mode 3 in case of V2X). If a transmission resource region is configured in advance or an eNB designates the transmission resource region and a UE directly selects a transmission resource from the transmission resource region, it is referred to as a mode 2 (mode 4 in case of V2X). In case of performing sidelink discovery, if an eNB directly indicates a resource, it is referred to as a type 2. If a UE directly selects a transmission resource from a predetermined resource region or a resource region indicated by the eNB, it is referred to as type 1.

In V2X, sidelink transmission mode 3 based on centralized scheduling and sidelink transmission mode 4 based on distributed scheduling are available.

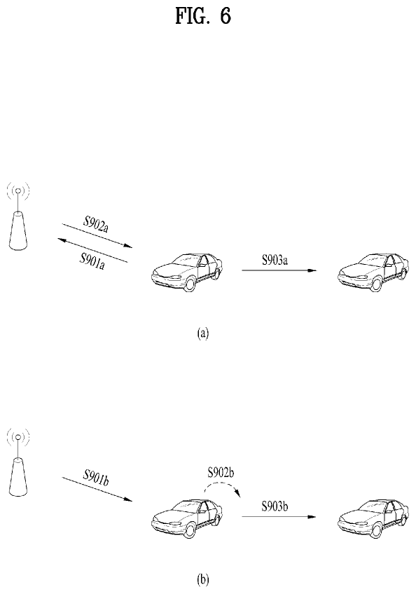

FIG. 6 illustrates scheduling schemes according to these two transmission modes. Referring to FIG. 6 (a), in transmission mode 3 based on centralized scheduling, when a vehicle requests sidelink resources to an eNB (S901a), the eNB allocates the resources (S902a), and the vehicle transmits a signal in the resources to another vehicle (S903a). In the centralized transmission scheme, resources of another carrier may be also scheduled. In distributed scheduling corresponding to transmission mode 4 illustrated in FIG. 6(b), a vehicle selects transmission resources (S902b), while sensing resources preconfigured by the eNB, that is, a resource pool (S901b), and then transmits a signal in the selected resources to another vehicle (S903b).

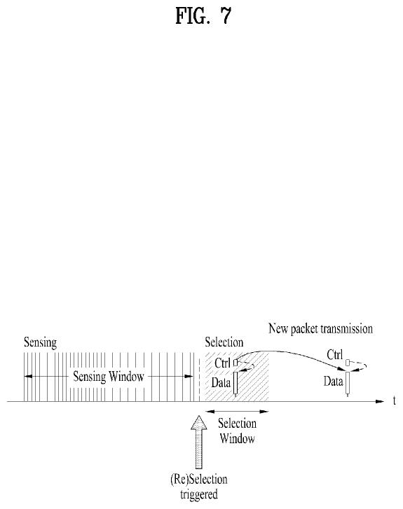

In this case, as shown in FIG. 7, transmission resource selection of the next packet is also reserved. In V2X, transmission is performed twice for each MAC PDU, and when resources for initial transmission are selected, resources for retransmission are reserved at a certain time gap. The terminal may identify transmission resources reserved by other terminals or resources used by other terminals through sensing within the sensing window. After excluding this in the selection window, the terminal may randomly select a resource from among remaining resources with little interference.

For example, the terminal may decode a PSCCH including information on the period of the reserved resources within the sensing window, and measure the PSSCH RSRP from resources periodically determined based on the PSCCH. Resources in which the PSSCH RSRP value exceeds a threshold value may be excluded from the selection window. Thereafter, a sidelink resource may be randomly selected from the remaining resources in the selection window.

Alternatively, by measuring Received Signal Strength Indication (RSSI) of periodic resources within the sensing window, less-interference resources corresponding to lower 20% are obtained. Subsequently, a sidelink resource may be randomly selected from the resources included in the selection window among the periodic resources. For example, in case of failing in decoding of PSCCH, such a method is usable.

For details of the resource reservation, see Section 14 of 3GPP TS 36.213 V14.6.0, which is incorporated herein as background art.

Transmission and Reception of PSCCH

A UE in sidelink transmission mode 1 may transmit a scheduling assignment (SA) (a sidelink signal or sidelink control information (SCI) or PSCCH) in resources configured by an eNB. A UE in sidelink transmission mode 2 may be configured with resources for sidelink transmission by the eNB, select time and frequency resources from among the configured resources, and transmit an SA in the selected time and frequency resources.

In sidelink transmission mode 1 or 2, an SA period may be defined as illustrated in FIG. 8.

Referring to FIG. 8, a first SA period may start in a subframe spaced from a specific system frame by a specific offset, SAOffsetIndicator indicated by higher-layer signaling. Each SA period may include an SA resource pool and a subframe pool for sidelink data transmission. The SA resource pool may include the first subframe of the SA period to the last of subframes indicated as carrying an SA by a subframe bitmap, saSubframeBitmap. The resource pool for sidelink data transmission may include subframes determined by a time-resource pattern for transmission (T-RPT) (or a time-resource pattern (TRP)) in mode 1. As illustrated, when the number of subframes included in the SA period except for the SA resource pool is larger than the number of T-RPT bits, the T-RPT may be applied repeatedly, and the last applied T-RPT may be truncated to include as many bits as the number of the remaining subframes. A transmitting UE performs transmission at T-RPT positions corresponding to is in a T-RPT bitmap, and one MAC PDU is transmitted four times.

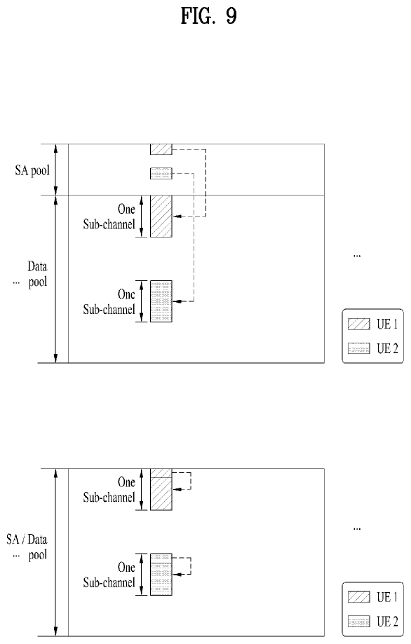

Unlike sidelink, an SA (PSCCH) and data (PSSCH) are transmitted in FDM in V2X, that is, sidelink transmission mode 3 or 4. Because latency reduction is a significant factor in V2X in view of the nature of vehicle communication, an SA and data are transmitted in FDM in different frequency resources of the same time resources. Examples of this transmission scheme are illustrated in FIG. 9. An SA and data may not be contiguous to each other as illustrated in FIG. 9(a) or may be contiguous to each other as illustrated in FIG. 9(b). Herein, a basic transmission unit is a subchannel A subchannel is a resource unit including one or more RBs on the frequency axis in predetermined time resources (e.g., a subframe). The number of RBs included in a subchannel, that is, the size of the subchannel and the starting position of the subchannel on the frequency axis are indicated by higher-layer signaling.

In V2V communication, a cooperative awareness message (CAM) of a periodic message type, a decentralized environmental notification message (DENM) of an event triggered message type, and so on may be transmitted. The CAM may deliver basic vehicle information including dynamic state information about a vehicle, such as a direction and a speed, static data of the vehicle, such as dimensions, an ambient illumination state, details of a path, and so on. The CAM may be 50 bytes to 300 bytes in length. The CAM is broadcast, and its latency should be shorter than 100 ms. The DENM may be generated, upon occurrence of an unexpected incident such as breakdown or an accident of a vehicle. The DENM may be shorter than 3000 bytes, and received by all vehicles within a transmission range. The DENM may have a higher priority than the CAM. When it is said that a message has a higher priority, this may mean that from the perspective of one UE, in the case of simultaneous transmission of messages, the higher-priority message is transmitted above all things, or earlier in time than any other of the plurality of messages. From the perspective of multiple UEs, a message having a higher priority may be subjected to less interference than a message having a lower priority, to thereby have a reduced reception error probability. Regarding the CAM, the CAM may have a larger message size when it includes security overhead than when it does not.

Sidelink Congestion Control

A sidelink radio communication environment may easily become congested according to increases in the density of vehicles, the amount of information transfer, etc. Various methods are applicable for congestion reduction. For example, distributed congestion control may be applied.

In the distributed congestion control, a UE understands the congestion level of a network and performs transmission control. In this case, the congestion control needs to be performed in consideration of the priorities of traffic (e.g., packets).

Specifically, each UE may measure a channel busy ratio (CBR) and then determine the maximum value (CRlimitk) of a channel occupancy ratio (CRk) that can be occupied by each traffic priority (e.g., k) according to the CBR. For example, the UE may calculate the maximum value (CRlimitk) of the channel occupancy ratio for each traffic priority based on CBR measurement values and a predetermined table. If traffic has a higher priority, the maximum value of the channel occupancy ratio may increase.

The UE may perform the congestion control as follows. The UE may limit the sum of the channel occupancy ratios of traffic with a priority k such that the sum does not exceed a predetermined value, where k is less than i. According to this method, the channel occupancy ratios of traffic with low priorities are further restricted.

Besides, the UE may use methods such as control of the magnitude of transmission power, packet drop, determination of retransmission or non-retransmission, and control of the size of a transmission RB (MCS adjustment).

5G Use Cases

Three key requirement areas of 5G (e.g., NR) include (1) enhanced mobile broadband (eMBB), (2) massive machine type communication (mMTC), and (3) ultra-reliable and low latency communications (URLLC).

Some use cases may require multiple dimensions for optimization, while others may focus only on one key performance indicator (KPI). 5G supports such diverse use cases in a flexible and reliable way.

eMBB goes far beyond basic mobile Internet access and covers rich interactive work, media and entertainment applications in the cloud or augmented reality (AR). Data is one of the key drivers for 5G and in the 5G era, we may for the first time see no dedicated voice service. In 5G, voice is expected to be handled as an application program, simply using data connectivity provided by a communication system. The main drivers for an increased traffic volume are the increase in the size of content and the number of applications requiring high data rates. Streaming services (audio and video), interactive video, and mobile Internet connectivity will continue to be used more broadly as more devices connect to the Internet. Many of these applications require always-on connectivity to push real time information and notifications to users. Cloud storage and applications are rapidly increasing for mobile communication platforms. This is applicable for both work and entertainment. Cloud storage is one particular use case driving the growth of uplink data rates. 5G will also be used for remote work in the cloud which, when done with tactile interfaces, requires much lower end-to-end latencies in order to maintain a good user experience. Entertainment, for example, cloud gaming and video streaming, is another key driver for the increasing need for mobile broadband capacity. Entertainment will be very essential on smart phones and tablets everywhere, including high mobility environments such as trains, cars and airplanes. Another use case is augmented reality (AR) for entertainment and information search, which requires very low latencies and significant instant data volumes.

One of the most expected 5G use cases is the functionality of actively connecting embedded sensors in every field, that is, mMTC. It is expected that there will be 20.4 billion potential Internet of things (IoT) devices by 2020. In industrial IoT, 5G is one of areas that play key roles in enabling smart city, asset tracking, smart utility, agriculture, and security infrastructure.

URLLC includes services which will transform industries with ultra-reliable/available, low latency links such as remote control of critical infrastructure and self-driving vehicles. The level of reliability and latency are vital to smart-grid control, industrial automation, robotics, drone control and coordination, and so on.

Now, multiple 5G use cases will be described in detail.

5G may complement fiber-to-the home (FTTH) and cable-based broadband (or data-over-cable service interface specifications (DOCSIS)) as a means of providing streams at data rates of hundreds of megabits per second to giga bits per second. Such a high speed is required for TV broadcasts at or above a resolution of 4K (6K, 8K, and higher) as well as virtual reality (VR) and AR. VR and AR applications mostly include immersive sport games. A special network configuration may be required for a specific application program. For VR games, for example, game companies may have to integrate a core server with an edge network server of a network operator in order to minimize latency.

The automotive sector is expected to be a very important new driver for 5G, with many use cases for mobile communications for vehicles. For example, entertainment for passengers requires simultaneous high capacity and high mobility mobile broadband, because future users will expect to continue their good quality connection independent of their location and speed. Other use cases for the automotive sector are AR dashboards. These display overlay information on top of what a driver is seeing through the front window, identifying objects in the dark and telling the driver about the distances and movements of the objects. In the future, wireless modules will enable communication between vehicles themselves, information exchange between vehicles and supporting infrastructure and between vehicles and other connected devices (e.g., those carried by pedestrians). Safety systems may guide drivers on alternative courses of action to allow them to drive more safely and lower the risks of accidents. The next stage will be remote-controlled or self-driving vehicles. These require very reliable, very fast communication between different self-driving vehicles and between vehicles and infrastructure. In the future, self-driving vehicles will execute all driving activities, while drivers are focusing on traffic abnormality elusive to the vehicles themselves. The technical requirements for self-driving vehicles call for ultra-low latencies and ultra-high reliability, increasing traffic safety to levels humans cannot achieve.

Smart cities and smart homes, often referred to as smart society, will be embedded with dense wireless sensor networks. Distributed networks of intelligent sensors will identify conditions for cost- and energy-efficient maintenance of the city or home. A similar setup can be done for each home, where temperature sensors, window and heating controllers, burglar alarms, and home appliances are all connected wirelessly. Many of these sensors are typically characterized by low data rate, low power, and low cost, but for example, real time high definition (HD) video may be required in some types of devices for surveillance.

The consumption and distribution of energy, including heat or gas, is becoming highly decentralized, creating the need for automated control of a very distributed sensor network. A smart grid interconnects such sensors, using digital information and communications technology to gather and act on information. This information may include information about the behaviors of suppliers and consumers, allowing the smart grid to improve the efficiency, reliability, economics and sustainability of the production and distribution of fuels such as electricity in an automated fashion. A smart grid may be seen as another sensor network with low delays.

The health sector has many applications that may benefit from mobile communications. Communications systems enable telemedicine, which provides clinical health care at a distance. It helps eliminate distance barriers and may improve access to medical services that would often not be consistently available in distant rural communities. It is also used to save lives in critical care and emergency situations. Wireless sensor networks based on mobile communication may provide remote monitoring and sensors for parameters such as heart rate and blood pressure.

Wireless and mobile communications are becoming increasingly important for industrial applications. Wires are expensive to install and maintain, and the possibility of replacing cables with reconfigurable wireless links is a tempting opportunity for many industries. However, achieving this requires that the wireless connection works with a similar delay, reliability and capacity as cables and that its management is simplified. Low delays and very low error probabilities are new requirements that need to be addressed with 5G.

Finally, logistics and freight tracking are important use cases for mobile communications that enable the tracking of inventory and packages wherever they are by using location-based information systems. The logistics and freight tracking use cases typically require lower data rates but need wide coverage and reliable location information.

Synchronization Acquisition of Sidelink UE.

In TDMA and FDMA systems, accurate time and frequency synchronization is essential. Inaccurate time and frequency synchronization may lead to degradation of system performance due to inter-symbol interference (ISI) and inter-carrier interference (ICI). The same is true for V2X. For time/frequency synchronization in V2X, a sidelink synchronization signal (SLSS) may be used in the PHY layer, and master information block-sidelink-V2X (MIB-SL-V2X) may be used in the RLC layer.

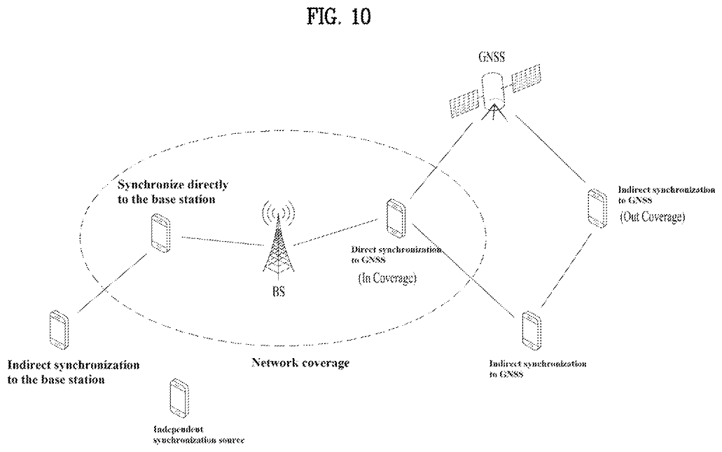

FIG. 10 illustrates a V2X synchronization source or reference to which the present disclosure is applicable.

Referring to FIG. 10, in V2X, a UE may be synchronized with a GNSS directly or indirectly through a UE (within or out of network coverage) directly synchronized with the GNSS. When the GNSS is configured as a synchronization source, the UE may calculate a direct subframe number (DFN) and a subframe number by using a coordinated universal time (UTC) and a (pre)determined DFN offset.

Alternatively, the UE may be synchronized with a BS directly or with another UE which has been time/frequency synchronized with the BS. For example, the BS may be an eNB or a gNB. For example, when the UE is in network coverage, the UE may receive synchronization information provided by the BS and may be directly synchronized with the BS. Thereafter, the UE may provide synchronization information to another neighboring UE. When a BS timing is set as a synchronization reference, the UE may follow a cell associated with a corresponding frequency (when within the cell coverage in the frequency), a primary cell, or a serving cell (when out of cell coverage in the frequency), for synchronization and DL measurement.

The BS (e.g., serving cell) may provide a synchronization configuration for a carrier used for V2X or sidelink communication. In this case, the UE may follow the synchronization configuration received from the BS. When the UE fails in detecting any cell in the carrier used for the V2X or sidelink communication and receiving the synchronization configuration from the serving cell, the UE may follow a predetermined synchronization configuration.

Alternatively, the UE may be synchronized with another UE which has not obtained synchronization information directly or indirectly from the BS or GNSS. A synchronization source and a preference may be preset for the UE. Alternatively, the synchronization source and the preference may be configured for the UE by a control message provided by the BS.

A sidelink synchronization source may be related to a synchronization priority. For example, the relationship between synchronization sources and synchronization priorities may be defined as shown in Table 2. Table 2 is merely an example, and the relationship between synchronization sources and synchronization priorities may be defined in various manners.

TABLE 2

| | | BS-based synchronization |
|---|---|---|
| | | (eNB/gNB-based |
| Priority | GNSS-based synchronization | synchronization) |
| P0 | GNSS | BS |
| P1 | All UEs directly | All UEs directly |
| | synchronized with GNSS | synchronized with BS |
| P2 | All UEs indirectly | All UEs indirectly |
| | synchronized with GNSS | synchronized with BS |
| P3 | All other UEs | GNSS |
| P4 | N/A | All UEs directly |
| | | synchronized with GNSS |
| P5 | N/A | All UEs indirectly |
| | | synchronized with GNSS |
| P6 | N/A | All other UEs |

Whether to use GNSS-based synchronization or BS-based synchronization may be (pre)determined. In a single-carrier operation, the UE may derive its transmission timing from an available synchronization reference with the highest priority.

In the conventional sidelink communication, the GNSS, eNB, and UE may be set/selected as the synchronization reference as described above. In NR, the gNB has been introduced so that the NR gNB may become the synchronization reference as well. However, in this case, the synchronization source priority of the gNB needs to be determined. In addition, a NR UE may neither have an LTE synchronization signal detector nor access an LTE carrier (non-standalone NR UE). In this situation, the timing of the NR UE may be different from that of an LTE UE, which is not desirable from the perspective of effective resource allocation. For example, if the LTE UE and NR UE operate at different timings, one TTI may partially overlap, resulting in unstable interference therebetween, or some (overlapping) TTIs may not be used for transmission and reception. To this end, various implementations for configuring the synchronization reference when the NR gNB and LTE eNB coexist will be described based on the above discussion. Herein, the synchronization source/reference may be defined as a synchronization signal used by the UE to transmit and receive a sidelink signal or derive a timing for determining a subframe boundary. Alternatively, the synchronization source/reference may be defined as a subject that transmits the synchronization signal. If the UE receives a GNSS signal and determines the subframe boundary based on a UTC timing derived from the GNSS, the GNSS signal or GNSS may be the synchronization source/reference.

Reporting & Signaling of Timing Difference Information Between NR gNB and LTE eNB

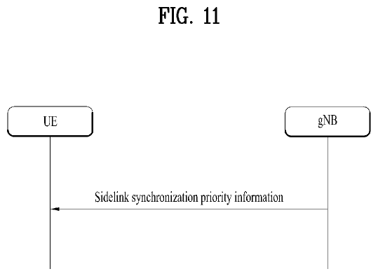

FIGS. 11 to 13 are flowcharts relating to various embodiments of the present disclosure.

A (sidelink) UE according to one embodiment of the present disclosure may select a sync reference according to a priority from a plurality of sync sources and then transmit or receive a sidelink signal based on the selected sync reference. Here, a priority between the eNB and the gNB may be configured by a BS or preconfigured by a network. Particularly, in case of an in-coverage UE, a priority may be configured by a BS. In case of an out-of-coverage UE, a priority may be preconfigured by a network. A plurality of sync sources may include an eNB and a gNB, and the eNB and the gNB may have the same priority. Namely, an LTE eNB may be configured to have the same priority as a gNB. Hence, in the priorities of Table 2, ‘BS’ may refer to both of an eNB and a gNB, or ‘BS’ may be substituted with ‘eNB/gNB’. Thus, by configuring the same priority for an eNB and a gNB, interference caused by UE's signal transmission can be reduced considerably. In a situation that synchronization signals of an eNB and a gNB can be detected, if a sync source priority of a specific BS type is configured high, it may cause strong asynchronous interference to other BS's communication. Specifically, it may happen that a UE located close to an eNB can detect a synchronization signal of a gNB (i.e., the corresponding UE may be located relatively far from the gNB in comparison to the eNB). In this case, if a sync source priority of the gNB is higher than that of the eNB, the UE performs a sidelink signal transmission operation using time/frequency synchronization derived from a synchronization signal of the gNB. In doing so, if synchronization is not matched between the eNB and the gNB, a sidelink signal transmission of the corresponding UE causes strong asynchronous interference to the communication of the eNB (i.e., the interference level is high because the corresponding terminal is located adjacent to the eNB). Therefore, the priorities of the eNB and the gNB are configured to be the same, thereby reducing influence of such interference.

For another example, a gNB may have a priority higher than that of a UE or be excluded from a sync source priority.

The priority may be received by a UE through one of higher layer signaling and physical layer signaling. For specific example, as shown in FIG. 11, a UE may receive priority related information (e.g., sidelink synchronization priority information, priority information, or information provided by the aforementioned network) from a gNB through a physical or higher layer signal. For example, all or some of a sync source priority of a gNB, whether a gNB is used as a sync reference, (if a gNB is used as a sync reference) a type of a sync source priority (e.g., a priority of a sidelink synchronization signal (gNB direct SLSS) transmitted by a UE directly synchronized with a gNB and a sidelink synchronization signal (eNB in-direct SLSS) transmitted by a UE indirectly synchronized with the gNB), priority relation with an LTE eNB or priority relation between an eNB direct SLSS and an eNB indirect SLSS, and the like may be signaled (or preconfigured) to a UE through a physical or higher layer signal of the gNB or the eNB.

If priorities of an eNB and a GNB are the same, a UE may select a sync reference based on signal strength (e.g., RSRP, RSRQ, etc.). Namely, if each of the eNB and the gNB is configured as the same priority, a sync reference having a great RSRP may be selected. Here, the RSRP/RSRQ may be measured based on at least one of PBCH DMRS, synchronization signal and Channel State Information (CSI). For example, it may include SS-RSRP, CSI-RSRP/RSRQ, etc. RSRP/RSRQ may be measured per Synchronization Signal Block (SSB) of a gNB. In case of a gNB, an RSRP may be different per beam according to multiple beam transmission. In this case, an RSRP per beam (or Synchronization Signal Block (SSB)) may be compared with an RSRP of an LTE eNB with a separately measured value, or compared with an RSRP of an LTE eNB with reference to a value of averaging/maximizing/minimizing/filtering RSRPs of several beams.

When the UE selects the sync reference having a great RSRP/RSRQ, an offset value indicated through one of physical layer signaling and higher layer signaling may be applied to one of an RSRP/RSRQ corresponding to the gNB and an RSRP/RSRQ corresponding to the eNB. Namely, an offset may be defined to give a bias to a BS of a specific type. In doing so, the used RSRP offset may be signaled to the UE by the eNB or the gNB through a physical or higher layer signal.

In addition, a network may appropriately determine a sync source priority of a gNB depending on UE's situation or capability. In this case, regarding making a determination depending on UE's situation, an LTE eNB is configured with a higher priority in an environment that a lot of NR non-standalone UEs exist. Otherwise, an NR gNB may be configured with a higher priority.

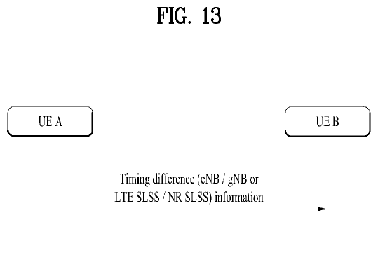

In some implementations, together with the aforementioned selection of the sync reference or as a separate operation, a UE may transmit a timing difference between an eNB and a gNB to at least one of the eNB, the gNB and other UEs. Namely, a UE may transmit a timing difference between an eNB and a gNB to at least one of the eNB and the gNB through an uplink channel, or a UE may transmit a timing difference between an eNB and a gNB to another UE through a sidelink channel Here, the timing difference may be determined from a synchronization signal received by the UE from each of the eNB and the gNB. In case of a UE capable of receiving both a synchronization signal of an LTE eNB and a synchronization signal of an NR gNB or a UE capable of receiving both LTE SLSS and NR SLSS, a timing difference between two different sync references derived from different BSs may be signaled to a surrounding UE or a network through a physical or higher layer signal. For specific example, as shown in FIG. 12, a UE may feed back a timing difference of eNB/gNB or an LTE/NR SLSS timing difference information in response to a request from the gNB or the eNB. For another example, as shown in FIG. 13, a UE may signal a timing difference of eNB/gNB or an LTE/NR SLSS timing difference information to another UE.

Through the above configuration, a UE detects a timing difference of different BSs and feeds it back to a surrounding UE or a surrounding BS, thereby helping a UE unaware of the timing difference to acquire synchronization or enabling a BS to help an NR gNB and an LTE gNB to match synchronization with each other in a manner of receiving such information and then adjusting a timing.

Cell Search

Cell search is a procedure for a UE to obtain time and frequency synchronization with a cell and detect a physical layer cell ID of the cell. To perform the cell search, the UE receives a Primary Synchronization Signal (PSS) and a Secondary Synchronization Signal (SSS).

The UE should assume that reception timing points of Physical Broadcast Channel (PBCH), PSS and SSS become consecutive symbols to form an SS/PBCH block. The UE should assume that SSS, PBCH, DM-RS and PBCH data have the same Energy Per Resource Element (EPRE). The UE may assume that a rate of SSS EPRE over PSS EPRE in SS/PBCH block of a corresponding cell is 0 dB or 3 dB.

The UE's cell search procedure may be summarized in Table 3.

TABLE 3

| | Type of | |
|---|---|---|
| | Signals | Operations |
| 1^{st} | PSS | SS/PBCH block (SSB) symbol timing acquisition |
| step | | Cell ID detection within a cell ID group |
| | | (3 hypothesis) |
| 2^{nd} | SSS | Cell ID group detection (336 hypothesis) |
| Step | | |
| 3^{rd} | PBCH | SSB index and Half frame index |
| Step | DMRS | (Slot and frame boundary detection) |
| 4^{th} | PBCH | Time information (80 ms, SFN, SSB index, HF) |
| Step | | RMSI CORESET/Search space configuration |
| 5^{th} | PDCCH and | Cell access information |
| Step | PDSCH | RACH configuration |

A synchronization signal block includes a primary/secondary synchronization signal (PSS, SSS) occupying 1 symbol and 127 subcarriers, and a PBCH block includes a PBCH that covers 3 OFDM symbols and 240 subcarriers.

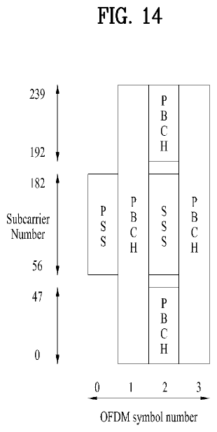

Referring to FIG. 14, one symbols is configured to leave an unused part in the middle, which is to transmit/receive SSS. Periodicity of an SS/PBCH block may be configured by a network, and a time position for transmitting an SS/PBCH block is determined by a subcarrier spacing.

Polar coding is used for PBCH. Unless a network configures a UE to assume a different subcarrier spacing, the UE may assume a band-specific subcarrier spacing for an SS/PBCH block.

A PBCH symbol has a unique frequency multiplexing DMRS. QPSK modulation is used for PBCH.

By referring to Equation 1 below, it is able to obtain 1,008 unique physical layer cell IDs.

N_{ID}^{cell}=3N_{ID}⁽¹⁾+N_{ID}⁽²⁾ [Equation 1]
where N_{ID}⁽¹⁾∈{0, 1, . . . , 355} and N_{ID}⁽²⁾∈{0,1,2}

A PSS sequence d_{PSS}(n) for PSS may be defined by referring to Equation 2 below.

d_{PSS}(n)=1−2x(m)

m=+(n+43N_{ID}⁽²⁾)mod 127

0≤n<127 [Equation 2]
where x(i+7)=(x(i+4)+x(i))mod 2
and
[x(6) x(5) x(4) x(3) x(2) x(1) x(0)]=[1 1 0 1 1 0]

For example, as shown in FIG. 14, the sequence may be mapped to a physical resource.

An SSS sequence d_{SSS}(n) for SSS may be defined by referring to Equation 3 below.

$${d}_{S S S} ( n ) = [ 1 - 2 {x}_{0} ( ( n + {m}_{0} ) mod 127 ) ] [ 1 - 2 {x}_{1} ( ( n + {m}_{1} ) mod 127 ) ] \\ {m}_{0} = 15 ⌊ \frac{{N}_{I D}^{( 1 )}}{112} ⌋ + 5 {N}_{I D}^{( 2 )} \\ {m}_{1} = {N}_{I D}^{( 1 )} mod 112 \\ 0 \leq n < 127 \\ {x}_{0} ( i + 7 ) = ( {x}_{0} ( i + 4 ) + {x}_{0} ( i ) ) mod 2 \\ {x}_{1} ( i + 7 ) = ( {x}_{1} ( i + 1 ) + {x}_{1} ( i ) ) mod 2 and \\ [ {x}_{0} ( 6 ) {x}_{0} ( 5 ) {x}_{0} ( 4 ) {x}_{0} ( 3 ) {x}_{0} ( 2 ) {x}_{0} ( 1 ) {x}_{0} ( 0 ) ] = \\ [ 0 \; 0 \; 0 \; 0 \; 0 \; 0 \; 1 ] \\ [ {x}_{1} ( 6 ) {x}_{1} ( 5 ) {x}_{1} ( 4 ) {x}_{1} ( 3 ) {x}_{1} ( 2 ) {x}_{1} ( 1 ) {x}_{1} ( 0 ) ] = \\ [ 0 \; 0 \; 0 \; 0 \; 0 \; 0 \; 1 ] \qquad [ Equation 3 ]$$

In case of a half frame having an SS/PBCH block, a first symbol index for a candidate SS/PBCH block may be determined according to a subcarrier spacing of an SS/PBCH block as follows.

CASE A—15 kHz subcarrier spacing: A first symbol of a candidate SS/PBCH block has indexes of ‘{2, 8}+14*n’. In case of a subcarrier frequency equal to or greater than 3 GHz, n=0, 1. In case of a subcarrier frequency greater than 3 GHz and equal to or smaller than 6 GHz, n=0, 1, 2, 3.

CASE B—30 kHz subcarrier spacing: A first symbol of a candidate SS/PBCH block has indexes of ‘{4, 8, 16, 20}+28*n’. In case of a subcarrier frequency equal to or smaller than 3 GHz, n=0. In case of a subcarrier frequency greater than 3 GHz and smaller than 6 GHz, n=0, 1.

CASE C—A first symbol of a candidate SS/PBCH block has indexes of ‘{2, 8}+14*n’. In case of a subcarrier frequency equal to or greater than 3 GHz, n=0, 1. In case of a subcarrier frequency greater than 3 GHz and equal to or smaller than 6 GHz, n=0, 1, 2, 3.

CASE D—120 kHz subcarrier spacing: A first symbol of a candidate SS/PBCH block has indexes of ‘{4, 8, 16, 20}+28*n’. In case of a subcarrier frequency greater than 6 GHz, n=0, 1, 2, 3, 5, 6, 7, 8, 10, 11, 12, 13, 15, 16, 17, 18.

CASE E—240 kHz subcarrier spacing: A first symbol of a candidate SS/PBCH block has indexes of ‘{8, 12, 16, 20, 32, 36, 40, 44}+56*n’. In case of a subcarrier frequency greater than 6 GHz, n=0, 1, 2, 3, 5, 6, 7, 8.

A candidate SS/PBCH block of a half frame is indexed in a time domain ranging from 0 to L−1 in ascending order. A UE should determine 2 LSBs for L=4 of an SS/PBCH block index per half frame or 3 LSBs for L>4 from one-to-one mapping having an index of a DM-RS sequence transmitted on PBCH. For L=64, the UE should determine 3 MSBs of an SS/PBCH block index per half frame by a PBCH payload ā_{Ā+5},ā_{Ā+6},ā_{Ā+7}.

A UE may be configured by a higher layer parameter SSB-transmitted-SIB1, and may be configured by indexes of SS/PBCH blocks on which the UE does not receive another signal or channel overlapping with an RE corresponding to SS/PBCH blocks. In addition, a UE may be configured per serving cell, configured by a higher layer parameter SSB-transmitted, and configured by indexes of SS/PBCH blocks on which the UE does not receive another signal or channel overlapping with an RE corresponding to SS/PBCH blocks. The configuration by SSB-transmitted is more preferential than the configuration by SSB-transmitted-SIB1. Regarding the UE, periodicity of a half frame may be configured for each serving cell by a higher layer parameter SSB-periodicityServingCell for the reception of SS/PBCH blocks per serving cell. If the UE does not configure periodicity for the repletion of SS/PBCH blocks, the UE should assume periodicity of the half frame. The UE should assume that the periodicity is the same for all SS/PBCH blocks of a serving cell.

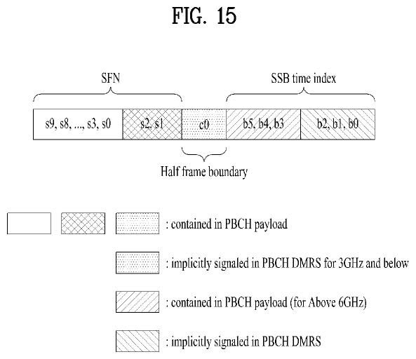

FIG. 15 is a diagram showing a method of obtaining timing information by a user equipment according to one embodiment of the present disclosure.

A UE may obtain 6-bit SFN information through a Master Information Block (MIB). Moreover, 4 bits of SFN may be obtained from a PBCH transport block.

The UE may obtain a 1-bit half frame mark as a part of a PBCH payload. In case of 3 GHz or less, a half frame mark is implicitly signaled as a part of a PBCH DMRS for Lₘₐₓ=4.

Finally, the UE may obtain an SS/PBCH block index by a DMRS sequence and a PBCH payload. Namely, 3 LSBs of an SS block index is obtained by a DMRS sequence in 5-ms periodicity. And, 3 MSBs of timing information is explicitly transferred on the PBCH payload (6 GHz or more).

For initial cell selection, a UE may assume that a half frame having an SS/PBCH block is generated by periodicity of 2 frames. In case of detection of an SS/PBCH block, the UE determines that a control resource set for a Tupe0-PDCCH common search space exists if k_{SSB}≤23 for FR1 and k_{SSB}≤11 for FR2. The UE determines that a control resource set for a Tupe0-PDCCH common search space does not exist if k_{SSB}>23 for FR1 and k_{SSB}>11 for FR2.

For a serving cell having no transmission of an SS/PBCH block, the UE obtains time and frequency synchronization with the serving cell based on a reception of an SS/PBCH block on PCell or PSCell of a cell group for the serving cell.

System Information Acquisition

System Information (SI) is classified into MasterInformationBlock (MIB) and several SystemInformationBlocks (SIB) as follows.

MasterInformationBlock (MIB) is always transmitted on BCH with periodicity of 80 ms (and repeatedly within 80 ms), and includes parameters required for obtaining SystemInformationBlockType1 (SIB1) from a cell.

SystemInformationBlockType1 (SIB1) is transmitted on DL-SCH periodically and repeatedly. SIB1 includes information on availability and scheduling (e.g., periodicity, SI window size, etc.) of another SIB. In addition, the SIB1 indicates whether other SIBs are provided based on periodic broadcast or on-demand. If other SIBs are provided on-demand, the SIB1 includes information for a UE to make an SI request.

SIBs other than SystemInformationBlockType1 are delivered on SystemInformation (SI) message and transmitted on DL-SCH. Each SI message is transmitted within a time domain window (e.g., SI-window) generated periodically.

In case of PSCell and SCell, a RAN provides necessary SI through a dedicated signaling. Nonetheless, a UE should obtain MIB of PSCell to obtain an SFN timing (possibly different from MCG) of an SCG. If SI relevant to SCell is changed, the RAN releases and adds a relevant SCell. In case of PSCell, SI may be changed only through reconfiguration by synchronization.

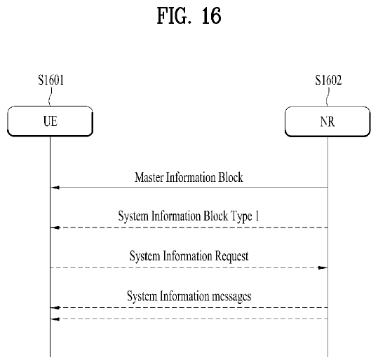

FIG. 16 is a flowchart showing one embodiment of the present disclosure.

Referring to FIG. 16, a UE 1601 obtains AS and NAS information by applying an SI obtaining procedure. Such a procedure applies to the UE 1601 in RRC_IDLE, RRC_INACTIVE or RRC_CONNECTED. Meanwhile, an NR 1602 shown in FIG. 16 may refer to a network, cell, RAT and/or BS, which supports NR communication.

The UE 1601 in RRC_IDLE or RRC_INACTIVE should have a valid version of (at least) MasterInformationBlock, SystemInformationBlockType1 and SystemInformationBlockTypeX through SystemInformationBlockTypeY (it may differ depending on a support of a relevant RAT for UE control mobility).

The UE 1601 in RRC_CONNECTED should be guaranteed to have a valid version of (at least) MasterInformationBlock, SystemInformationBlockType1 and SystemInformationBlockTypeX (depending on a support of mobility for a relevant RAT).

The UE 1601 should save the relevant SI currently obtained from a camping/serving cell. The version of the SI obtained and saved by the UE 1601 is valid for a specific time only. The UE 1601 may use the saved version of the SI when it returns out of coverage or after SI change indication (e.g., after cell reselection).

The present disclosure proposes a method of effectively configure a sync reference in a situation that an NR BS (gNB) and an LTE BS (eNB) coexist.

Sidelink communication may set a Global Navigation Satellite System (GNSS), a BS (e.g., eNB, gNB) and a UE as synchronization references. In this case, a BS (e.g., gNB) supportive of NR communication may become a sync reference, which may cause a problem that a synchronization source priority of the BS (e.g., gNB) should be determined. In addition, a UE (e.g., NR UE) supportive of NR communication may not implement an LTE synchronization signal detector or may not access an LTE carrier. (Standalone NR UE or non-stand-alone NR UE). Therefore, in such a situation, an LTE UE and an NR UE may have different timings, and such an operation is not preferable from the perspective of effective resource allocation. If the LTE UE and the NR UE operate in different timings, respectively, at least one Transmission Time Interval (TTI) may overlap partially to work as unstable interference or some TTI may be unusable for transmission and reception. To solve such a problem, the present disclosure proposes a method of effectively configuring a sync reference in a situation that an NR BS (gNB) and an LTE BS (eNB) coexist.

A synchronization signal used to derive a timing in order for a UE to derive a transmission/reception or subframe boundary of a sidelink signal may be defined as a synchronization source and/or a synchronization reference. Alternatively, as a subject or main agent that transmits a synchronization signal, a synchronization source and/or a synchronization reference may be defined. When a UE receives a GNSS signal and then derives a subframe boundary with reference to a Coordinated Universal Time (CUR) timing derived from the GNSS, the GNSS signal or the GNSS may become a synchronization source and/or a synchronization reference.

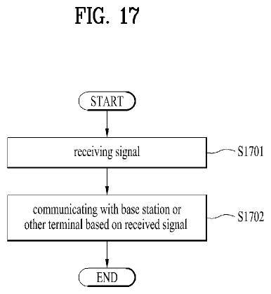

FIG. 17 is a flowchart showing one embodiment of the present disclosure.

Referring to FIG. 17, a method of receiving a signal by a UE in a wireless communication system according to one embodiment of the present disclosure may include a step S1701 of receiving a synchronization signal by the UE and a step S1702 of transceiving a signal with a BS or another UE based on the received synchronization signal. In addition, the UE may identify a type of the synchronization signal based on a shifted extent of a sequence of the synchronization signal. For example, a sequence d_{PSS}(n) of the synchronization signal may be represented as Equation 4 below. Here, N_{ID}⁽²⁾ may be 0, 1, or 2 and I may indicate a shifted extent.

d_{PSS}(n)=1−2x(m)

m=(n+43N_{ID}⁽²⁾+I)mod 127

0≤n<127 [Equation 4]

For one example, the type of the synchronization signal may include: i) a sidelink synchronization signal; or ii) a synchronization signal transmitted from a BS. In addition, based on the shifted extent of the sequence of the synchronization signal, the UE may determine whether the type of the synchronization signal is: i) the sidelink synchronization signal; or ii) the synchronization signal transmitted from the BS.

For another example, the type of the synchronization signal may include: i) a synchronization signal transmitted from a BS supportive of a New Radio (NR) communication system; or ii) a synchronization signal transmitted from a BS supportive of a Long Term Evolution (LTE) communication system. In addition, based on the shifted extent of the sequence of the synchronization signal, the UE may determine whether the type of the synchronization signal is: i) the synchronization signal transmitted from the BS supportive of the NR communication system; or ii) the synchronization signal transmitted from the BS supportive of the LTE communication system.

Sync Source Priority Configuring Operation of gNB

For one example, at least one of a sync source priority of a gNB, whether a gNB is used as a sync reference, (if a gNB is used as a sync reference) a type of a sync source priority (e.g., a priority of a sidelink synchronization signal (gNB direct SLSS) transmitted by a UE directly synchronized with a gNB and a sidelink synchronization signal (eNB in-direct SLSS) transmitted by a UE indirectly synchronized with the gNB), information indicating priority relation with an LTE eNB or priority relation between an eNB direct SLSS and an eNB indirect SLSS, and the like may be transmitted to a UE through physical or higher layer signaling of a BS. For another example, at least one of the above-described informations may be preconfigured by the BS or UE.

A network may determine a sync source priority of a gNB according to implementation, situation and performance (e.g., UE capability) of a UE.

A UE may receive information indicating at least one sync source or mode configured for UE capability from a BS. The sync mode may include: i) a first sync mode using a Global Navigation Satellite System (GNSS), an eNB, a gNB, an LTE sidelink UE, or an NR sidelink UE as a sync source; or ii) a second sync mode using a GNSS, a gNB, or an NR sidelink UE as a sync source. Meanwhile, the first sync mode may be provided for a UE having both LTE sidelink capability and NR sidelink capability (or a UE that targets LTE/NR sidelink capability, and the second sync mode may be provided for a UE having NR sidelink capability only (or a UE that targets NR sidelink capability only).

For one example, for a UE having both LTE sidelink capability and NR sidelink capability, an LTE sync source or a sync mode that considers all or some of priority-following or NR and LTE sync sources (e.g., GNSS<eNB, gNB, LTE (sidelink) UE and/or NR (sidelink) UE, etc.) may be defined.

For another example, for a UE having NR sidelink capability only, a sync mode that considers all or some of NR synchronization sources (e.g., GNSS, gNB, and/or NR (sidelink) UE, etc.) may be defined.

For example, a UE may receive information indicating at least one sync source or at least one sync mode configured per UE capability from a BS. To this end, a network (e.g., gNB, eNB, etc.) may signal a sync source and priority available per mode/UE capability to the UE through a physical or higher layer signal. For example, information on synchronization configuration (sync source and/or priority) for several sync modes may be signaled on SIB for sidelink to a UE.

For example, in an environment in which lots of non-standalone UEs exist, a higher priority may be configured for an LTE eNB. Otherwise, a higher priority may be configured for an NR gNB.

A priority higher (or lower) than that of a gNB may be configured for an LTE eNB. In this case, the gNB may have a priority higher than that of a UE or be excluded from a sync source priority.

When the same priority is configured for an eNB and a gNB, it is able to select a synchronization reference according to RSRP. In this case, an offset may be defined for the RSRP to give a bias to a BS of a specific type. The RSRP offset used for this may be signaled to a UE by the eNB or the gNB through a physical or higher layer signal.

In case of a gNB, an RSRP may be different per beam according to multiple beam transmission. In this case, an RSRP per beam (or Synchronization Signal Block (SSB)) may be compared with an RSRP of an LTE eNB with a separately measured value, or compared with an RSRP of an LTE eNB with reference to a value of averaging/maximizing/minimizing/filtering RSRPs of several beams.

An SLSS transmitted by a UE that uses an LTE eNB as a sync reference may have a priority higher than that of a gNB.

This is to enable NR UEs to be aligned as close to an LTE timing as possible and enable a UE, which fails to be equipped with an eNB synchronization signal detector by any chance, to follow the LTE timing effectively. In this case, the NR UE is assumed as implementing an LTE sidelink synchronization signal detector.

The reason why a high priority is configured for an LTE eNB is to enable a resource to be effectively TDMed between a UE driven in LTE sidelink and a UE driven in NR sidelink.

A gNB over a predetermined carrier frequency may be ruled not to be used as a sync (i.e., synchronization) reference.

As a coverage of a gNB is small over a predetermined frequency, a small number of UEs may exist in the coverage of the gNB. In this case, it may be inappropriate to use the gNB as a sync (i.e., synchronization) source.

If this is generalized, gNBs of frequencies lower than a predetermined frequency among gNBs may operate as sync references and a network may signal information, which indicates that gNBs of prescribed frequencies can become sync references, to a UE through a physical or higher layer signal.

Meanwhile, a network may designate a sync (i.e., synchronization) source priority per frequency. For example, the network may designate priorities in order of carriers A to C.

This is to select a specific frequency preferentially when a UE observes a gNB or eNB in several CCs. Namely, as described above, since an eNB/gNB of a specific frequency has a wider coverage, the eNB/gNB of the specific frequency may become a more appropriate synchronization reference.

In another method, when a message transmission of a UE is performed based on an NR format(/numerology) (e.g., when a service requirement can be satisfied by using an NR format(/numerology) only), the UE may be enabled to select an NR gNB (or an NR sidelink synchronization signal) with a higher priority.

This method is provided to protect NR communication when LTE and NR are asynchronously deployed.

A different synchronization source priority may be configured depending on UE's capability.

For example, depending on whether an LTE Uu Tx/Rx chain and/or an LTE sidelink synchronization Tx/Rx chain is implemented, it may be able to determine whether an LTE eNB or an LTE SLSS can be considered as a synchronization source.

Information indicating that an LTE eNB or an LTE SLSS has a prescribed synchronization source priority for a UE having implemented an LTE Uu Tx/Rx chain and/or an LTE sidelink synchronization Tx/Rx chain may be signaled to a UE by a network through a physical or higher layer signal.

Information indicating that an LTE SLSS has a prescribed synchronization source priority for a UE having implemented an LTE sidelink synchronization Tx/Rx chain without implementing an LTE Uu Tx/Rx chain may be signaled to a UE by a network through a physical or higher layer signal.

An applicable synchronization source priority may be configured differently depending on UE's multi-carrier capability or supportable band and a band combination.

For example, in case that a specific UE is accessible to an NR band only, NR gNB and gNB related SLSS (direct, indirect gNB SLSS), independent SLSS (out coverage), and GNSS related synchronization source priority may be configured for the corresponding UE.

For another example, a synchronization source priority for an LTE eNB may be preconfigured for a UE having LTE band accessible capability, or signaled to a UE through a higher layer signal.

A UE may transmit information, which indicates a type of a BS configured as a sync reference or a sync source, through a Sidelink Synchronization Signal (SLSS) or Physical Sidelink Broadcast Channel (PSHCH). When a UE selects an eNB or gNB as a sync reference and/or a sync source, the UE may indicate a type (e.g., eNB or gNB) of a BS through SLSS/PBSCH in order to inform a surrounding UE whether the UE itself uses a BS of a prescribed type as a sync reference and/or a sync source. For example, information indicating a type of a BS may be transmitted to a UE through SLSS/PBSCH. In this case, the information indicating the type of the BS may include at least one of information on separation of a resource to be used, a sidelink identifier, a PSBCH content, and a PSBCH DMRS.

Information on separation of a resource to be used may indicate that a resource used to transmit SLSS/PBSCH in case of using an eNB as a sync reference is configured in a manner different from that in case of using a gNB as a sync reference.

Regarding a sidelink identifier (e.g., SLSS ID), a UE may use a sidelink identifier differently depending on whether an eNB or a gNB is used as a sync reference. Alternatively, i) a root sequence of PSS or ii) a cyclic shift of PSS may be used differently. A configuration of such a set may be predetermined or indicated by a network.

Regarding a PSBCH content, a UE may indicate that a BS of a prescribed type is used as a sync reference through PSBCH.

Regarding a PSBCH DMRS, a UE may configure a PSBCH DMRS differently to indicate what kind of a type of a BS is used as a sync reference.

The above-proposed method may be used as a method for distinguishing a case of using SLSS/GNSS as a sync reference from another sync reference as well as distinguishment between an eNB and a gNB. For example, SLSS/PSBCH, which is transmitted when a GNSS is used as a sync reference, may be distinguished by all or some of the above method.

Meanwhile, a UE may receive: i) information indicating a reference for selecting at least one of a sync reference and a sync source; and/or ii) information indicating a reference for maintaining at least one of the selected sync reference and the selected sync source, from a BS. To control selection and maintenance of a specific sync reference (and/or sync source) more flexibly, when a network selects a specific sync reference, conditions (e.g., an RSRP threshold of a PSBCH DMRS or a hysteresis value (whether to change a sync source when this value is degraded to some extent)) for maintaining selection references (e.g., RSRP threshold, duration, PSBCH DMRS quality, PSS/SSS reception quality, etc.), a specific sync reference and the like may be signaled to a UE through a physical or higher layer signal. Through this control, the network may adjust a specific sync source to be selected more (or less) in a specific area.

Such a configuration may be established differently per sync mode described above.

Form and Configuration of NR Sidelink Synchronization Signal

NR Sidelink Synchronization Signal (SLSS) and/or Physical Sidelink Broadcast Channel (PSBCH) may have the form identical or similar to that of LTE Sidelink Synchronization Signal (SLSS) and/or LTE PSBCH. For example, NR SLSS may have a structure of repeating PSSS in a single subframe (or slot) twice and repeating SSSS in a single subframe (or slot) twice. In this case, the used PSSS/SSSS (of the NR SLSS) may have the same sequence generation scheme of PSSS/SSSS of LTE SLSS or have some property similar to that of the PSSS/SSSS of the LTE SLSS. This is to lower the implementation complexity by enabling an NR SLSS detector and an LTE SLSS detector to be reusable (entirely or in part).

For example, although NR SLSS has the same PSSS/SSSS of LTE SLSS, it may be configured in a manner that a symbol position is differently arranged in a slot.

Since LTE PSSS/SSSS is generated based on SC-FDMA waveform, regarding NR PSSS/SSSS, subcarrier mapping in a manner of shifting a half subcarrier in a Direct Current (DC) subcarrier direction centering on a DC subcarrier without puncturing the Direct Current (DC) subcarrier may be used for NR PSSS/SSSS generation.

Such a subcarrier mapping method may be applicable to transmission of other channels such as PSBCH/PSSCH/PSCCH.

Such a subcarrier mapping method may be determined by network signaling. For example, a network may signal an indication of using the subcarrier mapping scheme of the legacy LTE sidelink through a physical or higher layer signal. If there is no such signaling or it is indicated not to use the subcarrier mapping scheme of the LTE sidelink, a subcarrier mapping scheme used by the legacy NR may be usable.

NR SLSS and/or PSBCH may deform NR Synchronization Signal Block (SSB). For example, all or some of the following deformations are applicable.

A method of changing a position of PSS/PBCH/SSS is available. A UE may transmit a signal mapped in order of PSBCH (physical sidelink broadcast channel), PSS (primary synchronization signal), SSS (secondary synchronization signal), and PSBCH on a time axis. A current NR SSB has a symbol configuration in order of PSS/PBCH/SSS/PBCH. In order to prevent the legacy NR UES from detecting SLSS/PSBCH and protect PSSS in consideration of a period of performing Automatic Gain Control (AGC) in a first symbol of a sidelink slot, SLSS/PSBCH may be formed with the PSBCH/PSS/SSS/PSBCH configuration. Like NR SSB, some REs of a symbol in which PSS/SSS is transmitted may have PSBCH mapped thereto by transmission. In doing so, AGC is considered and it is also able to configure PSBCH by further using a single symbol to secure a coding rate of PBCH. For example, SLSS/PSBCH may be formed in the same configuration of PSBCH/PSBCH/PSS/SSS/PSBCH. The SLSS/PSBCH may be arranged in time order of PSBCH/PSBCH/PSS/SSS/PSBCH.

For another example, it is able to use a method of applying deformation of a cyclic shift of PSS and/or SSS. For example, Equation 2 described above may be deformed as Equation 5 below.

d_{PSS}(n)=1−2x(m)

m=(n+43N_{ID}⁽²⁾+I)mod 127

0≤n<127 [Equation 5]
where x(i+7)=(x(i+4)+x(i))mod 2
and
[x(6) x(5) x(4) x(3) x(2) x(1) x(0)]=[1 1 1 0 1 1 0]

Here, I may be a value predetermined for sidelink or a value configured different depending on a sync reference selected by a UE. This is to prevent the legacy NR UEs from detecting SLSS/PSBCH incorrectly in a manner of deforming a signal using a cyclic shift.

### Communication System Example to which Present Disclosure is Applied

Although not limited thereto, various descriptions, functions, procedures, proposals, methods, and/or operational flow charts of the present invention disclosed in this document can be applied to various fields requiring wireless communication/connection (5G) between devices.

Hereinafter, it will be illustrated in more detail with reference to the drawings. In the following drawings/description, the same reference numerals may exemplify the same or corresponding hardware blocks, software blocks, or functional blocks, unless otherwise indicated.

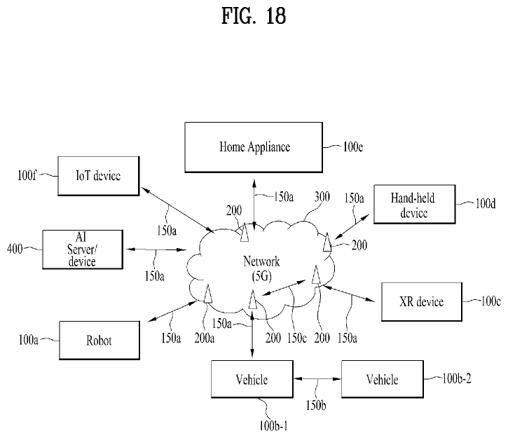

FIG. 18 illustrates a communication system applied to the present invention.

Referring to FIG. 18, a communication system 1 applied to the present invention includes wireless devices, Base Stations (BSs), and a network. Herein, the wireless devices represent devices performing communication using Radio Access Technology (RAT) (e.g., 5G New RAT (NR)) or Long-Term Evolution (LTE)) and may be referred to as communication/radio/5G devices. The wireless devices may include, without being limited to, a robot 100a, vehicles 100b-1 and 100b-2, an eXtended Reality (XR) device 100c, a hand-held device 100d, a home appliance 100e, an Internet of Things (IoT) device 100f, and an Artificial Intelligence (AI) device/server 400. For example, the vehicles may include a vehicle having a wireless communication function, an autonomous driving vehicle, and a vehicle capable of performing communication between vehicles. Herein, the vehicles may include an Unmanned Aerial Vehicle (UAV) (e.g., a drone). The XR device may include an Augmented Reality (AR)/Virtual Reality (VR)/Mixed Reality (MR) device and may be implemented in the form of a Head-Mounted Device (HMD), a Head-Up Display (HUD) mounted in a vehicle, a television, a smartphone, a computer, a wearable device, a home appliance device, a digital signage, a vehicle, a robot, etc. The hand-held device may include a smartphone, a smartpad, a wearable device (e.g., a smartwatch or a smartglasses), and a computer (e.g., a notebook). The home appliance may include a TV, a refrigerator, and a washing machine. The IoT device may include a sensor and a smartmeter. For example, the BSs and the network may be implemented as wireless devices and a specific wireless device 200a may operate as a BS/network node with respect to other wireless devices.

The wireless devices 100a to 100f may be connected to the network 300 via the BSs 200. An AI technology may be applied to the wireless devices 100a to 100f and the wireless devices 100a to 100f may be connected to the AI server 400 via the network 300. The network 300 may be configured using a 3G network, a 4G (e.g., LTE) network, or a 5G (e.g., NR) network. Although the wireless devices 100a to 100f may communicate with each other through the BSs 200/network 300, the wireless devices 100a to 100f may perform direct communication (e.g., sidelink communication) with each other without passing through the BSs/network. For example, the vehicles 100b-1 and 100b-2 may perform direct communication (e.g. Vehicle-to-Vehicle (V2V)/Vehicle-to-everything (V2X) communication). The IoT device (e.g., a sensor) may perform direct communication with other IoT devices (e.g., sensors) or other wireless devices 100a to 100f.

Wireless communication/connections 150a, 150b, or 150c may be established between the wireless devices 100a to 100f/BS 200, or BS 200/BS 200. Herein, the wireless communication/connections may be established through various RATs (e.g., 5G NR) such as uplink/downlink communication 150a, sidelink communication 150b (or, D2D communication), or inter BS communication (e.g. relay, Integrated Access Backhaul(IAB)). The wireless devices and the BSs/the wireless devices may transmit/receive radio signals to/from each other through the wireless communication/connections 150a and 150b. For example, the wireless communication/connections 150a and 150b may transmit/receive signals through various physical channels. To this end, at least a part of various configuration information configuring processes, various signal processing processes (e.g., channel encoding/decoding, modulation/demodulation, and resource mapping/demapping), and resource allocating processes, for transmitting/receiving radio signals, may be performed based on the various proposals of the present invention.

### Examples of Wireless Devices to which Present Disclosure is Applied

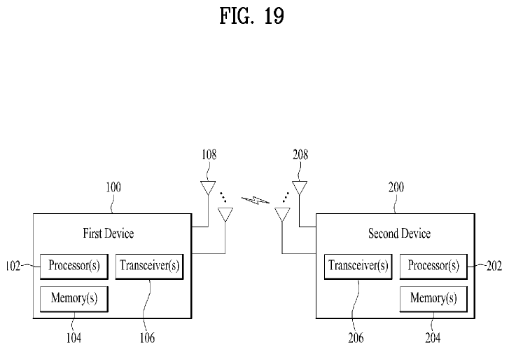

FIG. 19 illustrates a wireless device applicable to the present invention.

Referring to FIG. 19, a first wireless device 100 and a second wireless device 200 may transmit radio signals through a variety of RATs (e.g., LTE and NR). Herein, {the first wireless device 100 and the second wireless device 200} may correspond to {the wireless device 100x and the BS 200} and/or {the wireless device 100x and the wireless device 100x} of FIG. 18.

The first wireless device 100 may include one or more processors 102 and one or more memories 104 and additionally further include one or more transceivers 106 and/or one or more antennas 108. The processor(s) 102 may control the memory(s) 104 and/or the transceiver(s) 106 and may be configured to implement the descriptions, functions, procedures, proposals, methods, and/or operational flowcharts disclosed in this document. For example, the processor 102 may be configured to implement at least one operation for the methods described with reference to FIG. 17. For one example, the processor 102 may be configured to receive a synchronization signal by controlling the transceiver 106 and transceive signal with a BS or another UE based on the received synchronization signal. In addition, the processor 102 may be configured to identify a type of the synchronization signal based on a shifted extent of a sequence of the synchronization signal.

Also, the processor(s) 102 may process information within the memory(s) 104 to generate first information/signals and then transmit radio signals including the first information/signals through the transceiver(s) 106. The processor(s) 102 may receive radio signals including second information/signals through the transceiver 106 and then store information obtained by processing the second information/signals in the memory(s) 104. The memory(s) 104 may be connected to the processor(s) 102 and may store a variety of information related to operations of the processor(s) 102. For example, the memory(s) 104 may store software code including commands for performing a part or the entirety of processes controlled by the processor(s) 102 or for performing the descriptions, functions, procedures, proposals, methods, and/or operational flowcharts disclosed in this document. Herein, the processor(s) 102 and the memory(s) 104 may be a part of a communication modem/circuit/chip designed to implement RAT (e.g., LTE or NR). The transceiver(s) 106 may be connected to the processor(s) 102 and transmit and/or receive radio signals through one or more antennas 108. Each of the transceiver(s) 106 may include a transmitter and/or a receiver. The transceiver(s) 106 may be interchangeably used with Radio Frequency (RF) unit(s). In the present invention, the wireless device may represent a communication modem/circuit/chip.

The second wireless device 200 may include one or more processors 202 and one or more memories 204 and additionally further include one or more transceivers 206 and/or one or more antennas 208. The processor(s) 202 may control the memory(s) 204 and/or the transceiver(s) 206 and may be configured to implement the descriptions, functions, procedures, proposals, methods, and/or operational flowcharts disclosed in this document. For example, the processor(s) 202 may process information within the memory(s) 204 to generate third information/signals and then transmit radio signals including the third information/signals through the transceiver(s) 206. The processor(s) 202 may receive radio signals including fourth information/signals through the transceiver(s) 106 and then store information obtained by processing the fourth information/signals in the memory(s) 204. The memory(s) 204 may be connected to the processor(s) 202 and may store a variety of information related to operations of the processor(s) 202. For example, the memory(s) 204 may store software code including commands for performing a part or the entirety of processes controlled by the processor(s) 202 or for performing the descriptions, functions, procedures, proposals, methods, and/or operational flowcharts disclosed in this document. Herein, the processor(s) 202 and the memory(s) 204 may be a part of a communication modem/circuit/chip designed to implement RAT (e.g., LTE or NR). The transceiver(s) 206 may be connected to the processor(s) 202 and transmit and/or receive radio signals through one or more antennas 208. Each of the transceiver(s) 206 may include a transmitter and/or a receiver. The transceiver(s) 206 may be interchangeably used with RF unit(s). In the present invention, the wireless device may represent a communication modem/circuit/chip.

Hereinafter, hardware elements of the wireless devices 100 and 200 will be described more specifically. One or more protocol layers may be implemented by, without being limited to, one or more processors 102 and 202. For example, the one or more processors 102 and 202 may implement one or more layers (e.g., functional layers such as PHY, MAC, RLC, PDCP, RRC, and SDAP). The one or more processors 102 and 202 may generate one or more Protocol Data Units (PDUs) and/or one or more Service Data Unit (SDUs) according to the descriptions, functions, procedures, proposals, methods, and/or operational flowcharts disclosed in this document. The one or more processors 102 and 202 may generate messages, control information, data, or information according to the descriptions, functions, procedures, proposals, methods, and/or operational flowcharts disclosed in this document. The one or more processors 102 and 202 may generate signals (e.g., baseband signals) including PDUs, SDUs, messages, control information, data, or information according to the descriptions, functions, procedures, proposals, methods, and/or operational flowcharts disclosed in this document and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the descriptions, functions, procedures, proposals, methods, and/or operational flowcharts disclosed in this document

The one or more processors 102 and 202 may be referred to as controllers, microcontrollers, microprocessors, or microcomputers. The one or more processors 102 and 202 may be implemented by hardware, firmware, software, or a combination thereof. As an example, one or more Application Specific Integrated Circuits (ASICs), one or more Digital Signal Processors (DSPs), one or more Digital Signal Processing Devices (DSPDs), one or more Programmable Logic Devices (PLDs), or one or more Field Programmable Gate Arrays (FPGAs) may be included in the one or more processors 102 and 202. The descriptions, functions, procedures, proposals, methods, and/or operational flowcharts disclosed in this document may be implemented using firmware or software and the firmware or software may be configured to include the modules, procedures, or functions. Firmware or software configured to perform the descriptions, functions, procedures, proposals, methods, and/or operational flowcharts disclosed in this document may be included in the one or more processors 102 and 202 or stored in the one or more memories 104 and 204 so as to be driven by the one or more processors 102 and 202. The descriptions, functions, procedures, proposals, methods, and/or operational flowcharts disclosed in this document may be implemented using firmware or software in the form of code, commands, and/or a set of commands

The one or more memories 104 and 204 may be connected to the one or more processors 102 and 202 and store various types of data, signals, messages, information, programs, code, instructions, and/or commands. The one or more memories 104 and 204 may be configured by Read-Only Memories (ROMs), Random Access Memories (RAMs), Electrically Erasable Programmable Read-Only Memories (EPROMs), flash memories, hard drives, registers, cash memories, computer-readable storage media, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or radio signals/channels, mentioned in the methods and/or operational flowcharts of this document, to one or more other devices. The one or more transceivers 106 and 206 may receive user data, control information, and/or radio signals/channels, mentioned in the descriptions, functions, procedures, proposals, methods, and/or operational flowcharts disclosed in this document, from one or more other devices. For example, the one or more transceivers 106 and 206 may be connected to the one or more processors 102 and 202 and transmit and receive radio signals. For example, the one or more processors 102 and 202 may perform control so that the one or more transceivers 106 and 206 may transmit user data, control information, or radio signals to one or more other devices. The one or more processors 102 and 202 may perform control so that the one or more transceivers 106 and 206 may receive user data, control information, or radio signals from one or more other devices. The one or more transceivers 106 and 206 may be connected to the one or more antennas 108 and 208 and the one or more transceivers 106 and 206 may be configured to transmit and receive user data, control information, and/or radio signals/channels, mentioned in the descriptions, functions, procedures, proposals, methods, and/or operational flowcharts disclosed in this document, through the one or more antennas 108 and 208. In this document, the one or more antennas may be a plurality of physical antennas or a plurality of logical antennas (e.g., antenna ports). The one or more transceivers 106 and 206 may convert received radio signals/channels etc. from RF band signals into baseband signals in order to process received user data, control information, radio signals/channels, etc. using the one or more processors 102 and 202. The one or more transceivers 106 and 206 may convert the user data, control information, radio signals/channels, etc. processed using the one or more processors 102 and 202 from the base band signals into the RF band signals. To this end, the one or more transceivers 106 and 206 may include (analog) oscillators and/or filters.

### Example of Signal Processing Circuit to which Present Disclosure is Applied

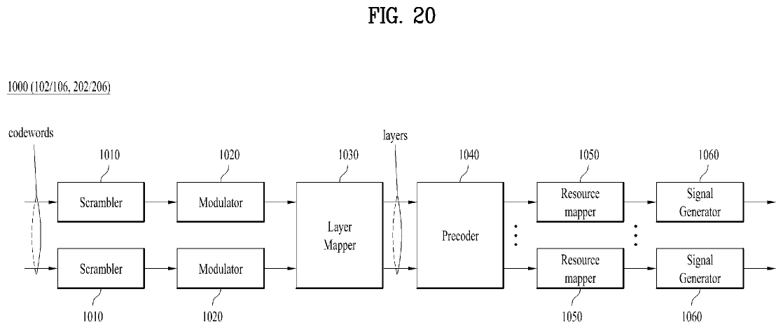

FIG. 20 illustrates a signal process circuit for a transmission signal.

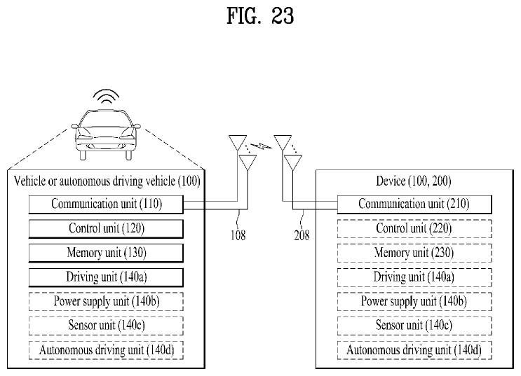

Referring to FIG. 20, a signal processing circuit 1000 may include scramblers 1010, modulators 1020, a layer mapper 1030, a precoder 1040, resource mappers 1050, and signal generators 1060. An operation/function of FIG. 20 may be performed, without being limited to, the processors 102 and 202 and/or the transceivers 106 and 206 of FIG. 23. Hardware elements of FIG. 20 may be implemented by the processors 102 and 202 and/or the transceivers 106 and 206 of FIG. 23. For example, blocks 1010 to 1060 may be implemented by the processors 102 and 202 of FIG. 23. Alternatively, the blocks 1010 to 1050 may be implemented by the processors 102 and 202 of FIG. 23 and the block 1060 may be implemented by the transceivers 106 and 206 of FIG. 23.

Codewords may be converted into radio signals via the signal processing circuit 1000 of FIG. 20. Herein, the codewords are encoded bit sequences of information blocks. The information blocks may include transport blocks (e.g., a UL-SCH transport block, a DL-SCH transport block). The radio signals may be transmitted through various physical channels (e.g., a PUSCH and a PDSCH).

Specifically, the codewords may be converted into scrambled bit sequences by the scramblers 1010. Scramble sequences used for scrambling may be generated based on an initialization value, and the initialization value may include ID information of a wireless device. The scrambled bit sequences may be modulated to modulation symbol sequences by the modulators 1020. A modulation scheme may include pi/2-Binary Phase Shift Keying (pi/2-BPSK), m-Phase Shift Keying (m-PSK), and m-Quadrature Amplitude Modulation (m-QAM). Complex modulation symbol sequences may be mapped to one or more transport layers by the layer mapper 1030. Modulation symbols of each transport layer may be mapped (precoded) to corresponding antenna port(s) by the precoder 1040. Outputs z of the precoder 1040 may be obtained by multiplying outputs y of the layer mapper 1030 by an N*M precoding matrix W. Herein, N is the number of antenna ports and M is the number of transport layers. The precoder 1040 may perform precoding after performing transform precoding (e.g., DFT) for complex modulation symbols. Alternatively, the precoder 1040 may perform precoding without performing transform precoding.

The resource mappers 1050 may map modulation symbols of each antenna port to time-frequency resources. The time-frequency resources may include a plurality of symbols (e.g., a CP-OFDMA symbols and DFT-s-OFDMA symbols) in the time domain and a plurality of subcarriers in the frequency domain. The signal generators 1060 may generate radio signals from the mapped modulation symbols and the generated radio signals may be transmitted to other devices through each antenna. For this purpose, the signal generators 1060 may include Inverse Fast Fourier Transform (IFFT) modules, Cyclic Prefix (CP) inserters, Digital-to-Analog Converters (DACs), and frequency up-converters.

Signal processing procedures for a signal received in the wireless device may be configured in a reverse manner of the signal processing procedures 1010 to 1060 of FIG. 20. For example, the wireless devices (e.g., 100 and 200 of FIG. 23) may receive radio signals from the exterior through the antenna ports/transceivers. The received radio signals may be converted into baseband signals through signal restorers. To this end, the signal restorers may include frequency downlink converters, Analog-to-Digital Converters (ADCs), CP remover, and Fast Fourier Transform (FFT) modules. Next, the baseband signals may be restored to codewords through a resource demapping procedure, a postcoding procedure, a demodulation processor, and a descrambling procedure. The codewords may be restored to original information blocks through decoding. Therefore, a signal processing circuit (not illustrated) for a reception signal may include signal restorers, resource demappers, a postcoder, demodulators, descramblers, and decoders

### Examples of Wireless Devices to which Present Disclosure is Applied

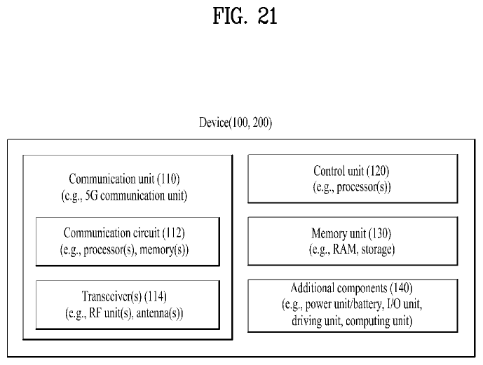

FIG. 21 illustrates another example of a wireless device applied to the present invention. The wireless device may be implemented in various forms according to a use-case/service (refer to FIGS. 19, 22-24).

Referring to FIG. 21, wireless devices 100 and 200 may correspond to the wireless devices 100 and 200 of FIG. 19 and may be configured by various elements, components, units/portions, and/or modules. For example, each of the wireless devices 100 and 200 may include a communication unit 110, a control unit 120, a memory unit 130, and additional components 140. The communication unit may include a communication circuit 112 and transceiver(s) 114. For example, the communication circuit 112 may include the one or more processors 102 and 202 and/or the one or more memories 104 and 204 of FIG. 19. For example, the transceiver(s) 114 may include the one or more transceivers 106 and 206 and/or the one or more antennas 108 and 208 of FIG. 19. The control unit 120 is electrically connected to the communication unit 110, the memory 130, and the additional components 140 and controls overall operation of the wireless devices. For example, the control unit 120 may control an electric/mechanical operation of the wireless device based on programs/code/commands/information stored in the memory unit 130. The control unit 120 may transmit the information stored in the memory unit 130 to the exterior (e.g., other communication devices) via the communication unit 110 through a wireless/wired interface or store, in the memory unit 130, information received through the wireless/wired interface from the exterior (e.g., other communication devices) via the communication unit 110. For example, the control unit 120 may be configured to implement at least one operation for the methods described with reference to FIG. 17. For one example, the control unit 120 may be configured to receive a synchronization signal by controlling the communication unit 110 and transceive signal with a BS or another UE based on the received synchronization signal. In addition, the control unit 120 may be configured to identify a type of the synchronization signal based on a shifted extent of a sequence of the synchronization signal.

The additional components 140 may be variously configured according to types of wireless devices. For example, the additional components 140 may include at least one of a power unit/battery, input/output (I/O) unit, a driving unit, and a computing unit. The wireless device may be implemented in the form of, without being limited to, the robot (100a of FIG. 18), the vehicles (100b-1 and 100b-2 of FIG. 18), the XR device (100c of FIG. 18), the hand-held device (100d of FIG. 18), the home appliance (100e of FIG. 18), the IoT device (100f of FIG. 18), a digital broadcast terminal, a hologram device, a public safety device, an MTC device, a medicine device, a fintech device (or a finance device), a security device, a climate/environment device, the AI server/device (400 of FIG. 18), the BSs (200 of FIG. 18), a network node, etc. The wireless device may be used in a mobile or fixed place according to a use-example/service.

In FIG. 21, the entirety of the various elements, components, units/portions, and/or modules in the wireless devices 100 and 200 may be connected to each other through a wired interface or at least a part thereof may be wirelessly connected through the communication unit 110. For example, in each of the wireless devices 100 and 200, the control unit 120 and the communication unit 110 may be connected by wire and the control unit 120 and first units (e.g., 130 and 140) may be wirelessly connected through the communication unit 110. Each element, component, unit/portion, and/or module within the wireless devices 100 and 200 may further include one or more elements. For example, the control unit 120 may be configured by a set of one or more processors. As an example, the control unit 120 may be configured by a set of a communication control processor, an application processor, an Electronic Control Unit (ECU), a graphical processing unit, and a memory control processor. As another example, the memory 130 may be configured by a Random Access Memory (RAM), a Dynamic RAM (DRAM), a Read Only Memory (ROM)), a flash memory, a volatile memory, a non-volatile memory, and/or a combination thereof.

Hereinafter, an example of implementing FIG. 21 will be described in detail with reference to the drawings.

### Examples of Mobile Devices to which Present Disclosure is Applied

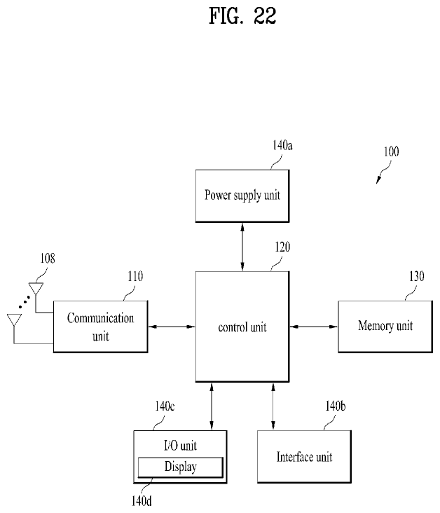

FIG. 22 illustrates a hand-held device applied to the present invention. The hand-held device may include a smartphone, a smartpad, a wearable device (e.g., a smartwatch or a smartglasses), or a portable computer (e.g., a notebook). The hand-held device may be referred to as a mobile station (MS), a user terminal (UT), a Mobile Subscriber Station (MSS), a Subscriber Station (SS), an Advanced Mobile Station (AMS), or a Wireless Terminal (WT).

Referring to FIG. 22, a hand-held device 100 may include an antenna unit 108, a communication unit 110, a control unit 120, a memory unit 130, a power supply unit 140a, an interface unit 140b, and an I/O unit 140c. The antenna unit 108 may be configured as a part of the communication unit 110. Blocks 110 to 130/140a to 140c correspond to the blocks 110 to 130/140 of FIG. 23, respectively.

The communication unit 110 may transmit and receive signals (e.g., data and control signals) to and from other wireless devices or BSs. The control unit 120 may perform various operations by controlling constituent elements of the hand-held device 100. The control unit 120 may include an Application Processor (AP). The memory unit 130 may store data/parameters/programs/code/commands needed to drive the hand-held device 100. The memory unit 130 may store input/output data/information. The power supply unit 140a may supply power to the hand-held device 100 and include a wired/wireless charging circuit, a battery, etc. The interface unit 140b may support connection of the hand-held device 100 to other external devices. The interface unit 140b may include various ports (e.g., an audio I/O port and a video I/O port) for connection with external devices. The I/O unit 140c may input or output video information/signals, audio information/signals, data, and/or information input by a user. The I/O unit 140c may include a camera, a microphone, a user input unit, a display unit 140d, a speaker, and/or a haptic module.

As an example, in the case of data communication, the I/O unit 140c may acquire information/signals (e.g., touch, text, voice, images, or video) input by a user and the acquired information/signals may be stored in the memory unit 130. The communication unit 110 may convert the information/signals stored in the memory into radio signals and transmit the converted radio signals to other wireless devices directly or to a BS. The communication unit 110 may receive radio signals from other wireless devices or the BS and then restore the received radio signals into original information/signals. The restored information/signals may be stored in the memory unit 130 and may be output as various types (e.g., text, voice, images, video, or haptic) through the I/O unit 140c.

### Examples of Vehicles or Autonomous Vehicles to which Present Disclosure is Applied

FIG. 23 illustrates a vehicle or an autonomous driving vehicle applied to the present invention. The vehicle or autonomous driving vehicle may be implemented by a mobile robot, a car, a train, a manned/unmanned Aerial Vehicle (AV), a ship, etc.

Referring to FIG. 23, a vehicle or autonomous driving vehicle 100 may include an antenna unit 108, a communication unit 110, a control unit 120, a driving unit 140a, a power supply unit 140b, a sensor unit 140c, and an autonomous driving unit 140d. The antenna unit 108 may be configured as a part of the communication unit 110. The blocks 110/130/140a to 140d correspond to the blocks 110/130/140 of FIG. 21, respectively

The communication unit 110 may transmit and receive signals (e.g., data and control signals) to and from external devices such as other vehicles, BSs (e.g., gNBs and road side units), and servers. The control unit 120 may perform various operations by controlling elements of the vehicle or the autonomous driving vehicle 100. The control unit 120 may include an Electronic Control Unit (ECU). For example, the control unit 120 may be configured to implement at least one operation for the methods described with reference to FIG. 17. For one example, the control unit 120 may be configured to receive a synchronization signal by controlling the communication unit 110 and transceive signal with a BS or another UE based on the received synchronization signal. In addition, the control unit 120 may be configured to identify a type of the synchronization signal based on a shifted extent of a sequence of the synchronization signal.

Also, the driving unit 140a may cause the vehicle or the autonomous driving vehicle 100 to drive on a road. The driving unit 140a may include an engine, a motor, a powertrain, a wheel, a brake, a steering device, etc. The power supply unit 140b may supply power to the vehicle or the autonomous driving vehicle 100 and include a wired/wireless charging circuit, a battery, etc. The sensor unit 140c may acquire a vehicle state, ambient environment information, user information, etc. The sensor unit 140c may include an Inertial Measurement Unit (IMU) sensor, a collision sensor, a wheel sensor, a speed sensor, a slope sensor, a weight sensor, a heading sensor, a position module, a vehicle forward/backward sensor, a battery sensor, a fuel sensor, a tire sensor, a steering sensor, a temperature sensor, a humidity sensor, an ultrasonic sensor, an illumination sensor, a pedal position sensor, etc. The autonomous driving unit 140d may implement technology for maintaining a lane on which a vehicle is driving, technology for automatically adjusting speed, such as adaptive cruise control, technology for autonomously driving along a determined path, technology for driving by automatically setting a path if a destination is set, and the like

For example, the communication unit 110 may receive map data, traffic information data, etc. from an external server. The autonomous driving unit 140d may generate an autonomous driving path and a driving plan from the obtained data. The control unit 120 may control the driving unit 140a such that the vehicle or the autonomous driving vehicle 100 may move along the autonomous driving path according to the driving plan (e.g., speed/direction control). In the middle of autonomous driving, the communication unit 110 may aperiodically/periodically acquire recent traffic information data from the external server and acquire surrounding traffic information data from neighboring vehicles. In the middle of autonomous driving, the sensor unit 140c may obtain a vehicle state and/or surrounding environment information. The autonomous driving unit 140d may update the autonomous driving path and the driving plan based on the newly obtained data/information. The communication unit 110 may transfer information about a vehicle position, the autonomous driving path, and/or the driving plan to the external server. The external server may predict traffic information data using AI technology, etc., based on the information collected from vehicles or autonomous driving vehicles and provide the predicted traffic information data to the vehicles or the autonomous driving vehicles.

### Examples of AR/VR & Vehicle to which Present Disclosure is Applied

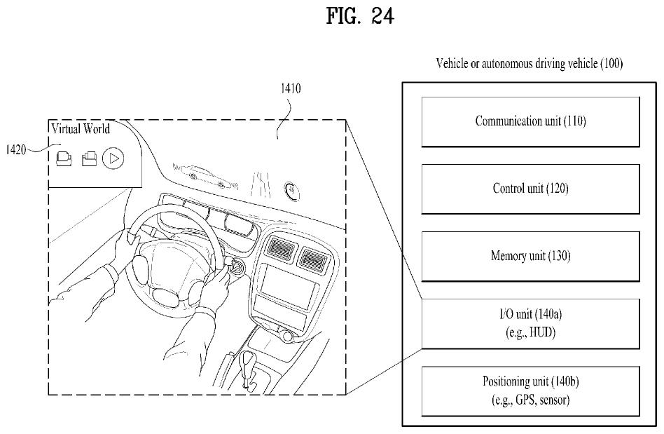

FIG. 24 illustrates a vehicle to which the present disclosure is applicable. The vehicle may be implemented as a transport means, a train, a flying object, a ship, etc.

Referring to FIG. 24, a vehicle 100 may include a communication unit 110, a control unit 120, a memory unit 130, an Input/Output (I/O) unit 1401 and a positioning unit 140b. here, the blocks 110-130/140a-140b correspond to the blocks 110-130/140 of FIG. 21, respectively.

The communication unit 110 may transmit and receive signals (e.g., data, control signal, etc.) with external devices such as other vehicles, BSs and the like. The control unit 120 may perform various operations by controlling components of the vehicle 100. The memory unit 130 may store data/parameters/programs/codes/commands for supporting various functions of the vehicle 100. The I/O unit 140a may output AR/VR objects based on information in the memory unit 130. The I/O unit 140a may include HUD. The positioning unit 140b may obtain position information of the vehicle 100. The position information may include absolute position information of the vehicle 100, position information of the vehicle 100 within a driveline, acceleration information of the vehicle 100, position information of the vehicle 100 with a surrounding vehicle, and the like. The positioning unit 140b may include GPS and various sensors.

For example, the communication unit 110 of the vehicle 100 may receive map information, traffic information and the like from an external server and then save them to the memory unit 130. The positioning unit 140b may obtain vehicle position information through the GPS and various sensor and then save it to the memory unit 130. The control unit 120 may generate a virtual object based on the map information, the traffic information, the vehicle position information and the like, and the I/O unit 140a may display the generated virtual object on a glass window in the vehicle [140m, 140n]. In addition, based on the vehicle position information, the control unit 120 may determine whether the vehicle 100 is normally driven on the driveline. If the vehicle 100 deviates from the driveline abnormally, the control unit 120 may display a warning on the glass window in the vehicle through the I/O unit 140a. In addition, the controller 120 may broadcast a warning message about the abnormal driving to surrounding vehicles through the communication unit 110. Depending on the circumstances, the control unit 12) may transmit information about the position of the vehicle and information about the driving/vehicle abnormality to the relevant agencies through the communication unit 110.

The embodiments described above are those in which components and features of the present invention are combined in a predetermined form. Each component or feature should be considered optional unless explicitly stated otherwise. Each component or feature may be implemented in a form that is not combined with other components or features. In addition, it is also possible to constitute an embodiment of the present invention by combining some components and/or features. The order of operations described in the embodiments of the present invention may be changed. Some configurations or features of one embodiment may be included in other embodiments, or may be replaced with corresponding configurations or features of other embodiments. It is obvious that the embodiments may be configured by combining claims that do not have an explicit citation relationship in the claims or may be included as new claims by amendment after filing.

In this document, embodiments of the present invention have been mainly described based on a signal transmission/reception relationship between a terminal and a base station. Such a transmission/reception relationship is extended in the same/similar manner to signal transmission/reception between a terminal and a relay or a base station and a relay. A specific operation described as being performed by a base station in this document may be performed by its upper node in some cases. That is, it is obvious that various operations performed for communication with a terminal in a network comprising a plurality of network nodes including a base station may be performed by the base station or network nodes other than the base station. The base station may be replaced by terms such as a fixed station, a Node B, an eNode B (eNB), an access point, and the like. In addition, the terminal may be replaced with terms such as User Equipment (UE), Mobile Station (MS), and Mobile Subscriber Station (MSS).

In a hardware configuration, the embodiments of the present disclosure may be achieved by one or more application specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, etc.

In a firmware or software configuration, a method according to embodiments of the present disclosure may be implemented in the form of a module, a procedure, a function, etc. Software code may be stored in a memory unit and executed by a processor. The memory unit is located at the interior or exterior of the processor and may transmit and receive data to and from the processor via various known means

As described before, a detailed description has been given of preferred embodiments of the present disclosure so that those skilled in the art may implement and perform the present disclosure. While reference has been made above to the preferred embodiments of the present disclosure, those skilled in the art will understand that various modifications and alterations may be made to the present disclosure within the scope of the present disclosure. For example, those skilled in the art may use the components described in the foregoing embodiments in combination. The above embodiments are therefore to be construed in all aspects as illustrative and not restrictive. The scope of the disclosure should be determined by the appended claims and their legal equivalents, not by the above description, and all changes coming within the meaning and equivalency range of the appended claims are intended to be embraced therein.

### INDUSTRIAL APPLICABILITY

The above-described embodiments of the present disclosure are applicable to various mobile communication systems.

What is claimed is:

1. A method of transmitting and receiving signals by a user equipment in a wireless communication system, the method comprising:
receiving a synchronization signal by the user equipment; and
transmitting and receiving the signals with a base station or another user equipment by the user equipment based on the received synchronization signal,
wherein the user equipment identifies a type of the synchronization signal based on a shifted extent of a sequence of the synchronization signal.

2. The method of claim 1, wherein the type of the synchronization signal includes a sidelink synchronization signal and a synchronization signal transmitted from the base station, and
wherein the method further comprises determining by the user equipment whether the type of the synchronization signal is the sidelink synchronization signal or the synchronization signal transmitted from the base station based on the shifted extent of the sequence of the synchronization signal.

3. The method of claim 1, wherein the type of the synchronization signal includes a synchronization signal transmitted from the base station supportive of a New Radio (NR) communication system and a synchronization signal transmitted from the base station supportive of a Long Term Evolution (LTE) communication system, and
wherein the method further comprises determining by the user equipment whether the type of the synchronization signal is the synchronization signal transmitted from the base station supportive of the NR communication system or the synchronization signal transmitted from the base station supportive of the LTE communication system.

4. The method of claim 1, further comprising receiving by the user equipment information indicating at least one sync source or at least one sync mode configured per User Equipment (UE) capability from the base station.

5. The method of claim 4, wherein the at least one sync mode includes two or more sync modes and wherein the two or more sync modes include a first sync mode of using a Global Navigation Satellite System (GNSS), an eNB, a gNB, an LTE sidelink user equipment and an NR sidelink user equipment as sync sources and a second sync mode of using the GNSS, the gNB and the NR sidelink user equipment as sync sources.

6. The method of claim 5, wherein the first sync mode is configured for a user equipment having LTE sidelink capability and NR sidelink capability and wherein the second sync mode is configured for a user equipment having the NR sidelink capability only.

7. The method of claim 1, further comprising transmitting by the user equipment information indicating the type of the base station configured by a first user equipment as the sync reference or the sync source through a Sidelink Synchronization Signal (SLSS) or a Physical Sidelink Broadcast Channel (PSBCH).

8. The method of claim 1, further comprising receiving by the user equipment at least one of information indicating a reference for selecting at least one of the sync reference or the sync source and information indicating a reference for maintaining at least one of the selected sync reference or the selected sync source from the base station.

9. The method of claim 1, further comprising transmitting a signal mapped in order of Physical Sidelink Broadcast Channel (PSBCH), Primary Synchronization Signal (PSS), Secondly Synchronization Signal (SSS) and PSBCH on a time axis.

10. A user equipment transmitting and receiving signals in a wireless communication system, the user equipment comprising:
a transceiver; and
a processor configured to receive a synchronization signal and transmit and receive the signals with a base station or another user equipment based on the received synchronization signal,
wherein the user equipment identifies a type of the synchronization signal based on a shifted extent of a sequence of the synchronization signal.

11. The user equipment of claim 10, wherein the user equipment communicates with at least one of a mobile terminal, a network and an autonomous vehicle other than the device.

12. The user equipment of claim 10, wherein the user equipment implements at least one Advanced Driver Assistance System (ADAS) function based on a signal for controlling a motion of the user equipment.

13. The user equipment of claim 10, wherein the user equipment receives a user's input so as to switch a driving mode of a device to a manual driving mode from an autonomous driving mode, and vice versa.

14. The user equipment of claim 10, wherein the user equipment is driven autonomously based on an external object information and wherein the external object information includes at least one of information on a presence or non-presence of an object, location information of the object, distance information between the user equipment and the object, or relative speed information between the user equipment and the object.
